(19) United States
(12) Patent Application Publication
(10) Pub. No.: US 2026/0110360 A1
(43) Pub. Date: Apr. 23, 2026

(54) ELECTRIC ACTUATOR

(71) Applicant: NIDEC POWERTRAIN SYSTEMS CORPORATION, Zama-shi (JP)

(72) Inventor: Kei SATO, Zama-shi (JP)

(21) Appl. No.: 19/360,029

(22) Filed: Oct. 16, 2025

(30) Foreign Application Priority Data
Oct. 18, 2024 (JP) 2024-184143

(51) Int. Cl. F16H 63/34; H02P 23/00

(52) U.S. Cl. CPC F16H 63/3466; F16H 63/3433; H02P 23/00

(57) ABSTRACT

An electric actuator includes an output shaft coupled to a first portion, a motor to rotate the output shaft, a rotation sensor to detect a rotation angle of the output shaft, and a controller. A valley portion of the first portion includes first and second inclined surfaces and a bottom portion. The controller is configured or programmed to obtain a bottom position rotation angle when a contact position corresponds to the bottom portion. The obtaining control includes alternately repeating first and second rotational driving to rotate the output shaft, setting an output torque of the motor in the first rotational driving to be smaller than an output torque that allows the contact portion to climb over the first inclined surface, switching from the first rotational driving to the second rotational driving when the output shaft is determined to be stopped in the first rotational driving, and reducing the output torque of the motor.

### CROSS-REFERENCE TO RELATED APPLICATIONS

The present application claims priority under 35 U.S.C. § 119 to Japanese Patent Application No. 2024-184143, filed on Oct. 18, 2024, the entire contents of which are hereby incorporated herein by reference.

### 1. Field of the Invention

The present disclosure relates to electric actuators.

### 2. Background

An electric actuator that drives a switching mechanism such as a park lock mechanism based on a vehicle operation is known. The switching mechanism driven by the electric actuator includes, for example, a detent plate and a positioning mechanism that holds a rotation angle of the detent plate by fitting a portion of a plate spring member into a valley portion provided on an outer peripheral edge of the detent plate.

The electric actuator as described above may be able to execute a learning method for learning a rotation angle of the output shaft that rotates the detent plate, in order to set the rotation angle to a position at which a portion of the plate spring member is accurately fitted to the valley portion provided on the outer peripheral edge of the detent plate. As such a learning method, for example, there is known a method using abutting learning control in which a wall is provided on the outer peripheral edge of the detent plate, a force applied from the electric actuator to the detent plate is released after the plate spring member abuts against the wall, and the rotation angle of the output shaft when the position of the detent plate is corrected by the resilient force of the plate spring member is learned. However, in this method, there is a problem that the rotation angle of the output shaft cannot be accurately learned, for example, when the wall cannot be provided on the outer peripheral edge of the detent plate due to some restrictions, when the rotation angle of the output shaft does not change even if the force applied to the detent plate is released after the detent plate abuts against the wall due to a self-holding function, or the like.

### SUMMARY

An electric actuator according to an example embodiment of the present disclosure is configured to rotationally drive a first portion having a plate shape, the plate shape including a plate surface and an outer peripheral edge, around a central axis orthogonal or substantially orthogonal to the plate surface to change a contact position of a second portion including a contact portion, the contact portion being in contact with the outer peripheral edge. The electric actuator includes an output shaft coupled to the first portion, a motor to rotate the output shaft around the central axis, a rotation sensor to detect a rotation angle of the output shaft, and a controller configured or programmed to control the motor. The outer peripheral edge includes a valley portion that includes a first inclined surface, a second inclined surface located on one side of the first inclined surface in a circumferential direction around the central axis, and a bottom portion to connect the first inclined surface and the second inclined surface. The controller is configured or programmed to execute obtaining control to obtain, as a bottom position rotation angle, a rotation angle of the output shaft at a time when the contact position corresponds to the bottom portion. The obtaining control includes, from a state where a rotation angle of the output shaft is a start angle at which the contact position corresponds to the valley portion, alternately repeating first rotational driving to rotate the output shaft to one side in the circumferential direction around the central axis and second rotational driving to rotate the output shaft to another side in the circumferential direction around the central axis, setting an output torque of the motor in the first rotational driving to be smaller than an output torque that allows the contact portion to climb over the first inclined surface, switching from the first rotational driving to the second rotational driving when the output shaft is determined to be stopped in the first rotational driving, and reducing the output torque of the motor in the first rotational driving each time the first rotational driving is performed.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a drive device according to an example embodiment of the present disclosure.

FIG. 2 is a perspective view illustrating a switching mechanism according to an example embodiment of the present disclosure.

FIG. 3 is a diagram illustrating a detent plate according to an example embodiment of the present disclosure.

FIG. 4 is a sectional diagram illustrating an electric actuator according to an example embodiment of the present disclosure.

FIG. 5 is a diagram illustrating a portion of an electric actuator according to an example embodiment of the present disclosure.

FIG. 6 is a block diagram illustrating a system configuration of an electric actuator according to an example embodiment of the present disclosure.

FIG. 7 is a block diagram illustrating a functional block of an electric actuator according to an example embodiment of the present disclosure.

FIG. 8 is a flowchart illustrating an example of obtaining control for a valley portion according to an example embodiment of the present disclosure.

FIG. 9A is a diagram illustrating first rotational driving in obtaining control for a valley portion according to an example embodiment of the present disclosure.

FIG. 9B is a diagram illustrating second rotational driving in obtaining control for a valley portion according to an example embodiment of the present disclosure.

FIG. 10 is a diagram illustrating an example of a change in an output torque of a motor and a change in a rotation angle of an output shaft, in obtaining control for a valley portion according to an example embodiment of the present disclosure.

FIG. 11 is a flowchart illustrating an example of obtaining control for another valley portion according to an example embodiment of the present disclosure.

FIG. 12A is a diagram illustrating first rotational driving in obtaining control for another valley portion according to an example embodiment of the present disclosure.

FIG. 12B is a diagram illustrating second rotational driving in obtaining control for another valley portion according to an example embodiment of the present disclosure.

FIG. 12C is a diagram illustrating first rotational driving for a second time in obtaining control for another valley portion according to an example embodiment of the present disclosure.

FIG. 13 is a diagram illustrating an example of a change in an output torque of a motor and a change in a rotation angle of an output shaft in obtaining control for another valley portion of an example embodiment of the present disclosure.

### DETAILED DESCRIPTION

In the drawings, a central axis J1 of an output shaft 46 of an electric actuator 10 of an example embodiment of the present described below is illustrated in a virtual manner as appropriate. In the following description, unless otherwise specified, the axial direction of the central axis J1 is simply referred to as an “axial direction”. A radial direction centered on the central axis J1 is simply referred to as a “radial direction”. A circumferential direction centered on the central axis J1, that is, the circumferential direction around the central axis J1 is simply referred to as a “circumferential direction”. An X-axis illustrated in each drawing indicates a direction in which a central axis J1 extends. The Y-axis illustrated in each drawing indicates one direction orthogonal or substantially orthogonal to the X-axis direction. The Z-axis illustrated in each drawing indicates a direction orthogonal or substantially orthogonal to both the X-axis direction and the Y-axis direction. In the following description, a direction along the Y-axis is referred to as a “width direction”, and a direction along the Z-axis is referred to as an “up-down direction”. The width direction is a left-right direction of a vehicle on which a drive device 1 in the following example embodiment is mounted, that is, a vehicle width direction. The up-down direction is an up-down direction of a vehicle on which the drive device 1 in the following example embodiment is mounted. The axial direction is a front-rear direction of a vehicle on which the drive device 1 in the following example embodiment is mounted.

A side (+X side) in the axial direction to which the arrow of the X-axis is directed is referred to as “one side in the axial direction”, and a side (−X side) in the axial direction opposite to the side to which the arrow of the X-axis is directed is referred to as “the other side in the axial direction”. A side (+Y side) in the width direction to which the arrow of the Y-axis is directed is referred to as “one side in the width direction”, and a side (−Y side) in the width direction opposite to the side to which the arrow of the Y-axis is directed is referred to as “the other side in the width direction”. A side (+Z side) in the up-down direction to which the arrow of the Z-axis is directed is referred to as an “upper side”, and a side (−Z side) in the up-down direction opposite to the side to which the arrow of the Z-axis is directed is referred to as a “lower side”. The up-down direction, the width direction, the upper side, and the lower side are merely names for describing the relative positional relationship of each portion, and the actual arrangement relationship and the like may be an arrangement relationship and the like other than the arrangement relationship and the like indicated by these names.

In the drawings, an arrow θ indicating the circumferential direction is illustrated as appropriate. In the following description, unless otherwise specified, a side (+θ side) directed in the counterclockwise direction centered on the central axis J1 as viewed from one side (+X side) in the axial direction in the circumferential direction is referred to as “one side in the circumferential direction”, and a side (−θ side) directed in the clockwise direction centered on the central axis J1 as viewed from one side (+X side) in the axial direction in the circumferential direction is referred to as “the other side in the circumferential direction”.

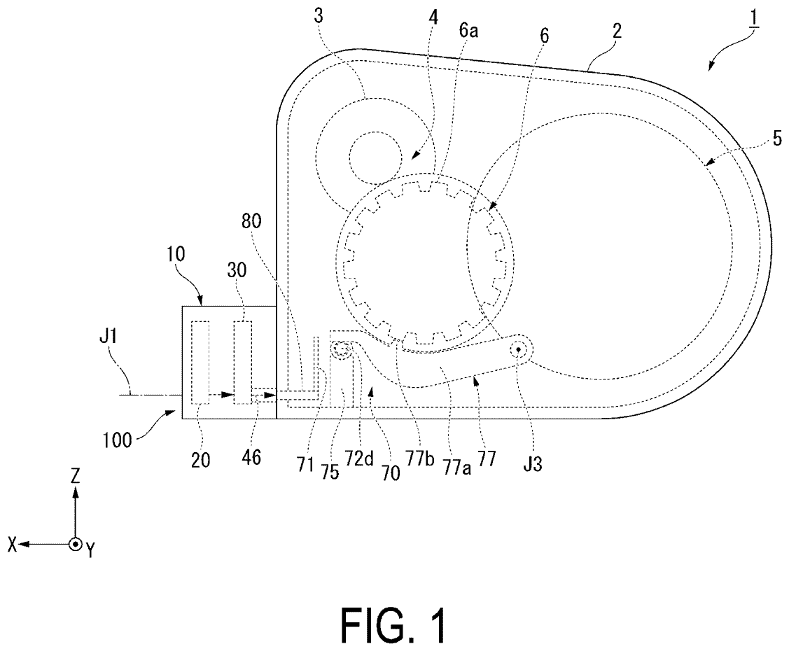

The electric actuator 10 illustrated in FIG. 1 is an electric actuator mounted on the drive device 1 mounted on a vehicle. The vehicle on which the drive device 1 is mounted is a vehicle using a motor as a power source, such as a hybrid electric vehicle (HEV), a plug-in hybrid vehicle (PHV), or an electric vehicle (EV). The drive device 1 of the present example embodiment is used as a power source of a vehicle on which the drive device 1 is mounted. The drive device 1 rotates an axle of the vehicle.

As illustrated in FIG. 1, the drive device 1 includes a housing 2, a drive motor 3, a speed reduction device 4, a differential device 5, a park lock gear 6, and a parking mechanism 100. The parking mechanism 100 includes the electric actuator 10 and a switching mechanism 70. The switching mechanism 70 includes a coupling shaft 80 coupled to the electric actuator 10. The coupling shaft 80 extends in the axial direction centered on the central axis J1. The electric actuator 10 rotates the coupling shaft 80 about the central axis J1.

The housing 2 accommodates the drive motor 3, the speed reduction device 4, the differential device 5, and the switching mechanism 70 therein. Although not illustrated, for example, oil is accommodated inside the housing 2. The speed reduction device 4 is connected to the drive motor 3. The differential device 5 is connected to the speed reduction device 4, and transmits the torque output from the drive motor 3 to an axle of the vehicle. The park lock gear 6 is fixed to a gear provided in the speed reduction device 4. The park lock gear 6 is coupled to an axle of the vehicle via the speed reduction device 4 and the differential device 5. The park lock gear 6 includes a plurality of tooth portions 6a.

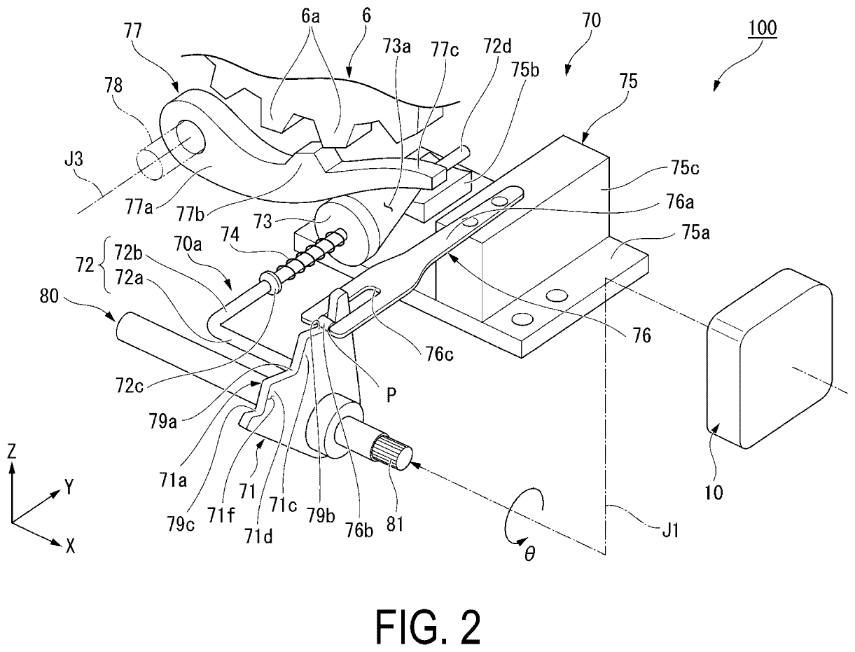

The switching mechanism 70 is driven by the electric actuator 10 based on a shift operation of the vehicle. The switching mechanism 70 switches the park lock gear 6 between the locked state and the unlocked state. The switching mechanism 70 sets the park lock gear 6 to the locked state when the shift position of the vehicle is the parking position (P range), and sets the park lock gear 6 to the unlocked state when the shift position of the vehicle is a non-parking position other than the parking position. The case where the shift position of the vehicle is the non-parking position includes, for example, a case where the shift position of the vehicle is a drive position (D range), a neutral position (N range), a reverse position (R range), or the like. As illustrated in FIG. 2, the switching mechanism 70 includes the coupling shaft 80, a movable portion 70a, a park lock arm 77, a base member 75, and a plate spring member 76.

The coupling shaft 80 couples the electric actuator 10 and the movable portion 70a between the electric actuator 10 and the movable portion 70a. The coupling shaft 80 transmits the power of the electric actuator 10 to the movable portion 70a. An end portion 81 of the coupling shaft 80 on one side (+X side) in the axial direction is connected to the electric actuator 10. The end portion 81 is provided with a plurality of spline grooves extending in the axial direction along the circumferential direction. The coupling shaft 80 is coupled to a detent plate 71 of the movable portion 70a. The coupling shaft 80 rotates integrally with the detent plate 71 around the central axis J1 by the power of the electric actuator 10.

The movable portion 70a moves in the width direction (Y-axis direction) based on a shift operation in the vehicle. In the present example embodiment, the movable portion 70a is moved by the electric actuator 10 via the coupling shaft 80. The position of the movable portion 70a in the width direction is switched at least between a non-parking position and a parking position. That is, the movable portion 70a is moved between the parking position and the non-parking position by the electric actuator 10. The non-parking position is a position of the movable portion 70a in the width direction when the shift position is other than the parking position. The parking position is a position of the movable portion 70a in the width direction when the shift position is the parking position. The parking position is a position on the one side (+Y side) in the width direction with respect to the non-parking position. FIG. 2 illustrates a case where the movable portion 70a is located at the non-parking position.

The movable portion 70a includes the detent plate 71, a rod 72, a cone-shaped member 73, and a coil spring 74. The detent plate 71 is fixed to the coupling shaft 80. The detent plate 71 is rotated about the central axis J1 by the coupling shaft 80. The detent plate 71 extends radially outward from the coupling shaft 80. In the present example embodiment, the detent plate 71 extends upward from the coupling shaft 80. In the present example embodiment, the detent plate 71 has a plate shape such that a plate surface 71f faces the axial direction (X-axis direction). The detent plate 71 has a substantially fan shape. The detent plate 71 includes a plate surface 71f orthogonal or substantially orthogonal to the central axis J1 and an outer peripheral edge 71a that is an edge portion on the outer side in the radial direction. In the present example embodiment, the detent plate 71 corresponds to a “first portion”.

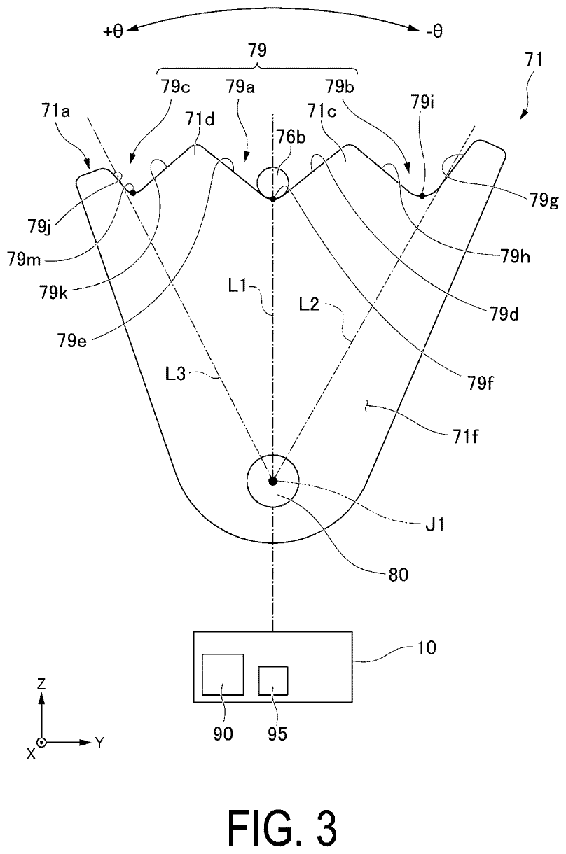

As illustrated in FIG. 3, in the present example embodiment, the outer peripheral edge 71a of the detent plate 71 includes three or more valley portions 79 disposed side by side in the circumferential direction around the central axis J1. In the present example embodiment, three valley portions 79 including a valley portion 79a, a valley portion 79b, and a valley portion 79c are provided. The valley portion 79c is the valley portion 79 located on the most one side (+θ side) in the circumferential direction among the three valley portions 79. The valley portion 79b is the valley portion 79 located on the most other side (−θ side) in the circumferential direction among the three valley portions 79. The valley portion 79a is the valley portion 79 located between the valley portion 79c located closest to the one side (+θ side) and the valley portion 79b located closest to the other side (−θ side) in the circumferential direction around the central axis J1 among the three valley portions 79. The valley portion 79c corresponds to, for example, a parking position. The valley portions 79a and 79b correspond to, for example, non-parking positions. Each valley portion 79 is recessed inward in the radial direction centered on the central axis J1 in the outer peripheral edge 71a of the detent plate 71. Each valley portion 79 penetrates the detent plate 71 in the axial direction. A mountain portion 71c protruding radially outward is provided in a portion between the valley portion 79a and the valley portion 79b in the circumferential direction. A mountain portion 71d protruding radially outward is provided in a portion between the valley portion 79a and the valley portion 79c in the circumferential direction.

The valley portion 79a includes a first inclined surface 79d, a second inclined surface 79e, and a bottom portion 79f. The first inclined surface 79d and the second inclined surface 79e are surfaces inclined in the radial direction with respect to the circumferential direction. The first inclined surface 79d is located on the radially inner side toward one side (+θ side) in the circumferential direction. The second inclined surface 79e is located on the radially inner side toward the other side (−θ side) in the circumferential direction. The second inclined surface 79e is located on the one side (+θ side) of the first inclined surface 79d in the circumferential direction around the central axis J1. The first inclined surface 79d and the second inclined surface 79e are inclined in different directions from each other. When viewed in the axial direction, the absolute value of the inclination angle of the first inclined surface 79d with respect to the circumferential direction is the same as the absolute value of the inclination angle of the second inclined surface 79e with respect to the circumferential direction. In the present example embodiment, the first inclined surface 79d and the second inclined surface 79e are disposed in line symmetry with respect to an imaginary line L1 passing through the central axis J1 and the bottom portion 79f and extending in the radial direction when viewed in the axial direction. The first inclined surface 79d and the second inclined surface 79e are separated from each other in the circumferential direction toward the radially outer side. When viewed in the axial direction, the absolute value of the inclination angle of the first inclined surface 79d with respect to the circumferential direction may be different from the absolute value of the inclination angle of the second inclined surface 79e with respect to the circumferential direction.

The bottom portion 79f connects the first inclined surface 79d and the second inclined surface 79e. More specifically, the bottom portion 79f connects an end portion of the first inclined surface 79d on the one side (+θ side) in the circumferential direction and an end portion of the second inclined surface 79e on the other side (−θ side) in the circumferential direction. The bottom portion 79f is a portion orthogonal or substantially orthogonal to the radial direction centered on the central axis J1. The first inclined surface 79d and the bottom portion 79f are smoothly connected to each other. The second inclined surface 79e and the bottom portion 79f are smoothly connected to each other. A portion of the first inclined surface 79d connected to the bottom portion 79f, a portion of the second inclined surface 79e connected to the bottom portion 79f, and a portion including the bottom portion 79f have an arc shape recessed inward in the radial direction when viewed in the axial direction.

The valley portion 79b includes a first inclined surface 79g, a second inclined surface 79h, and a bottom portion 79i. When viewed in the axial direction, the absolute inclination angle of the first inclined surface 79g with respect to the circumferential direction is greater than the absolute inclination angle of the second inclined surface 79h with respect to the circumferential direction. The first inclined surface 79g is inclined in the circumferential direction with respect to an imaginary line L2 passing through the central axis J1 and the first inclined surface 79g and extending in the radial direction as viewed in the axial direction. Other features in each portion of the valley portion 79b are the same as other features in each portion of the valley portion 79a.

The valley portion 79c includes a first inclined surface 79j, a second inclined surface 79k, and a bottom portion 79m. When viewed in the axial direction, the absolute inclination angle of the first inclined surface 79j with respect to the circumferential direction is greater than the absolute inclination angle of the second inclined surface 79k with respect to the circumferential direction. The first inclined surface 79j is inclined in the circumferential direction with respect to an imaginary line L3 passing through the central axis J1 and the first inclined surface 79j and extending in the radial direction as viewed in the axial direction. The second inclined surface 79k is located on the other side (−θ side) in the circumferential direction of the first inclined surface 79j. The size of the first inclined surface 79j in the radial direction is smaller than the size of the first inclined surface 79g in the valley portion 79b in the radial direction. The radially outer end portion of the first inclined surface 79j is located radially inward of the radially outer end portion of the first inclined surface 79g. The other features of the valley portion 79c are the same as other features of the valley portion 79a except that are disposed in line symmetry with respect to the imaginary line L1 when viewed in the axial direction. The valley portion 79b and the valley portion 79c may be asymmetrical with respect to the imaginary line L1 when viewed in the axial direction. Further, the valley portion 79a is provided between the valley portion 79b and the valley portion 79c in the circumferential direction, may be provided at the center between the valley portion 79b and the valley portion 79c in the circumferential direction, or may be provided at a position shifted in the circumferential direction from the center between the valley portion 79b and the valley portion 79c in the circumferential direction.

As illustrated in FIG. 2, the rod 72 is disposed to be movable in the width direction (Y-axis direction). The rod 72 includes a connecting portion 72a and a rod body portion 72b. The connecting portion 72a has a rod shape extending in the axial direction (X-axis direction). An end portion of the connecting portion 72a on the one side (+X side) in the axial direction penetrates the detent plate 71 in the axial direction and is fixed to the detent plate 71. Thus, the rod 72 is coupled to the coupling shaft 80 via the detent plate 71. The rod body portion 72b has a bar shape extending in the width direction. In the present example embodiment, the rod body portion 72b extends from an end portion of the connecting portion 72a on the other side (−X side) in the axial direction toward the one side (+Y side) in the width direction. The rod body portion 72b includes a projection portion 72c in a portion located on the other side (−Y side) in the width direction of the cone-shaped member 73. A tubular member 72d extending in the width direction is fitted and fixed to an end portion of the rod body portion 72b on the one side in the width direction.

The cone-shaped member 73 has a cone shape through which the rod body portion 72b is passed. The cone-shaped member 73 extends in the width direction (Y-axis direction). A portion of the outer peripheral surface of the cone-shaped member 73 on the one side (+Y side) in the width direction is a tapered surface 73a having an outer diameter decreasing toward the one side in the width direction. The cone-shaped member 73 is movable in the width direction with respect to the rod body portion 72b.

The coil spring 74 extends in the width direction (Y-axis direction). The coil spring 74 is disposed between the cone-shaped member 73 and the projection portion 72c in the width direction. The rod body portion 72b is passed through the coil spring 74. An end portion of the coil spring 74 on the other side (−Y side) in the width direction is in contact with the projection portion 72c. An end portion of the coil spring 74 on the one side (+Y side) in the width direction is in contact with a surface of the cone-shaped member 73 on the other side in the width direction. When the cone-shaped member 73 moves in the width direction relative to the rod body portion 72b, the coil spring 74 expands and contracts to apply a resilient force in the width direction to the cone-shaped member 73.

The park lock arm 77 is located on the other side (−X side) of the movable portion 70a in the axial direction. The park lock arm 77 is rotatably supported by a support shaft 78 centered on the rotation axis J3 extending in the width direction (Y-axis direction). The park lock arm 77 includes a park lock arm body portion 77a and a meshing portion 77b.

The park lock arm body portion 77a extends from the support shaft 78 to the one side (+X side) in the axial direction. An end portion 77c of the park lock arm body portion 77a on the one side in the axial direction contacts the movable portion 70a from above. The meshing portion 77b protrudes upward from the park lock arm body portion 77a. A coil spring (not illustrated) is attached to the support shaft 78. The coil spring (not illustrated) applies a clockwise resilient force centered on the rotation axis J3 as viewed from the other side (−Y side) in the width direction to the park lock arm 77.

The park lock arm 77 moves in accordance with the movement of the movable portion 70a. More specifically, the park lock arm 77 rotates around the rotation axis J3 as the rod 72 and the cone-shaped member 73 move in the width direction (Y-axis direction). When the detent plate 71 rotates from the non-parking position to the parking position in accordance with the rotation of the coupling shaft 80, the rod 72 and the cone-shaped member 73 move to the one side (+Y side) in the width direction.

The outer diameter of the tapered surface 73a of the cone-shaped member 73 increases from the one side (+Y side) in the width direction toward the other side (−Y side) in the width direction. Therefore, when the cone-shaped member 73 moves to the one side in the width direction, the end portion 77c of the park lock arm 77 is lifted upward by the tapered surface 73a, and the park lock arm 77 rotates counterclockwise about the rotation axis J3 as viewed from the other side (−Y side) in the width direction. As a result, although not illustrated, the meshing portion 77b approaches the park lock gear 6 and meshes between the tooth portions 6a of the park lock gear 6.

When the park lock gear 6 and the park lock arm 77 mesh with each other, the cone-shaped member 73 is also located at the parking position, and the entire movable portion 70a is located at the parking position. That is, the park lock arm 77 meshes with the park lock gear 6 coupled to the axle when the movable portion 70a is located at the parking position. In the parking position, the cone-shaped member 73 is sandwiched between a support portion 75b, which will be described below, of the base member 75 and the park lock arm 77 while being in contact therewith. When the park lock arm 77 meshes with the park lock gear 6, the park lock gear 6 is in a locked state.

When the detent plate 71 rotates from the parking position to the non-parking position in accordance with the rotation of the coupling shaft 80, the rod 72 and the cone-shaped member 73 move to the other side (−Y side) in the width direction. When the cone-shaped member 73 moves to the other side in the width direction, the end portion 77c of the park lock arm 77 lifted by the cone-shaped member 73 receives its own weight and a resilient force from the coil spring (not illustrated) and moves downward, and the park lock arm 77 rotates clockwise about the rotation axis J3 as viewed from the other side (−Y side) in the width direction. As a result, the meshing portion 77b of the park lock arm 77 separates from the park lock gear 6 and disengages from between the tooth portions 6a. In FIG. 2, the park lock arm 77 is illustrated disengaged from the park lock gear 6. When the park lock arm 77 is disengaged from the park lock gear 6, the park lock gear 6 enters the unlocked state.

The base member 75 supports the movable portion 70a to be movable in the width direction (Y-axis direction). In the present example embodiment, the base member 75 supports the movable portion 70a from below. The base member 75 is fixed to the inner side surface of the housing 2. The base member 75 includes a base plate 75a, a support portion 75b, and a plate spring fixing portion 75c.

In the present example embodiment, the base plate 75a has a plate shape in which plate surfaces face the up-down direction. The support portion 75b protrudes upward from the base plate 75a. The support portion 75b is a portion that comes into contact with the movable portion 70a and supports the movable portion 70a. In the present example embodiment, the support portion 75b is in contact with the cone-shaped member 73 of the movable portion 70a from below to support the movable portion 70a from below. The surface of the support portion 75b on the movable portion 70a side is an arc-shaped curved surface that is concave toward the side opposite to the movable portion 70a side when viewed in the width direction (Y-axis direction). Therefore, the cone-shaped member 73 including the tapered surface 73a can be stably supported. The plate spring fixing portion 75c protrudes upward from the base plate 75a. The plate spring fixing portion 75c has, for example, a rectangular parallelepiped shape. The plate spring fixing portion 75c is located on the one side (+X side) in the axial direction with respect to the support portion 75b.

The plate spring member 76 is fixed to a plate spring fixing portion 75c of the base member 75. In the present example embodiment, the plate spring member 76 is fixed to an end portion on the other side (−Y side) in the width direction of an upper side face of the plate spring fixing portion 75c. In the present example embodiment, the plate spring member 76 corresponds to a “second portion”. The plate spring member 76 includes a plate spring body portion 76a and a contact portion 76b.

The plate spring body portion 76a has a plate shape whose plate surfaces face the up-down direction. The plate spring body portion 76a extends from the plate spring fixing portion 75c toward the other side (−Y side) in the width direction. The plate spring body portion 76a extends to the upper side of the detent plate 71. The plate spring body portion 76a includes a slit 76c at an end portion on the other side in the width direction. The slit 76c penetrates the plate spring body portion 76a in the up-down direction. The slit 76c extends in the width direction (Y-axis direction). The slit 76c extends to an end portion of the plate spring body portion 76a on the other side in the width direction, and bifurcates the end portion of the plate spring body portion 76a on the other side in the width direction.

The contact portion 76b is provided at an end portion of the plate spring body portion 76a on the other side (−Y side) in the width direction. In the present example embodiment, the contact portion 76b is a roller attached to the plate spring body portion 76a so as to be rotatable about a shaft extending in the axial direction (X-axis direction). The contact portion 76b is provided between the tip portions of the plate spring body portion 76a bifurcated by the slit 76c.

The contact portion 76b is pressed against the outer peripheral edge 71a of the detent plate 71 by a resilient force generated in the plate spring member 76. In the following description, a position at which the contact portion 76b comes into contact with the outer peripheral edge 71a is referred to as a contact position P. The contact position P is a contact position of the plate spring member 76 with respect to the outer peripheral edge 71a. The contact portion 76b is located in the valley portion 79c when the movable portion 70a is located at the parking position. As a result, the contact portion 76b is caught on the inner side surface of the valley portion 79c in the circumferential direction, and the detent plate 71 and the rod 72 are maintained at the parking position. The contact portion 76b is located in the valley portion 79a or the valley portion 79b when the movable portion 70a is located at the non-parking position. As a result, the contact portion 76b is caught on the inner side surface of the valley portion 79a or the inner side surface of the valley portion 79b in the circumferential direction, and the detent plate 71 and the rod 72 are maintained at the non-parking position.

When the detent plate 71 rotates around the central axis J1, the contact portion 76b relatively moves from the inside of one valley portion 79 to the inside of another valley portion 79 over the mountain portions 71c and 71d respectively provided between the valley portions 79. When the contact portion 76b climbs over the mountain portion 71c or the mountain portion 71d, the plate spring member 76 receives a radially outward force from the mountain portion 71c or the mountain portion 71d via the contact portion 76b, and is elastically deformed. That is, in the present example embodiment, the plate spring member 76 is an elastic member that is elastically deformed by being pressed upward by the mountain portions 71c and 71d of the detent plate 71 when the movable portion 70a moves between the non-parking position and the parking position. As described above, the plate spring member 76 in the present example embodiment is an elastic member including the contact portion 76b that comes into contact with any one of the plurality of valley portions 79 by the resilient force generated with the rotation of the detent plate 71. In the present example embodiment, when the contact portion 76b relatively moves on the outer peripheral edge 71a of the detent plate 71, the contact portion 76b, which is a roller, moves while rolling on the outer peripheral edge 71a of the detent plate 71.

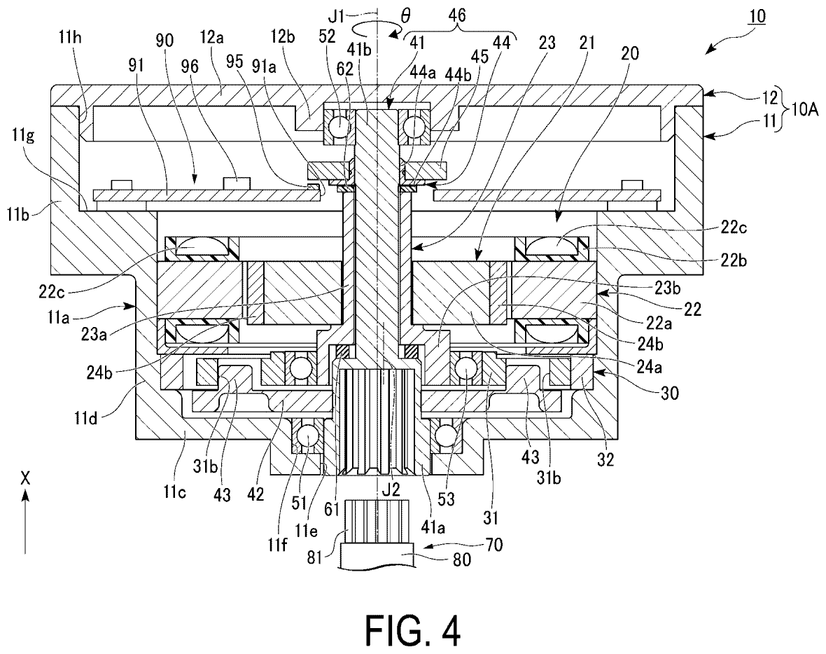

The electric actuator 10 illustrated in FIG. 4 drives the switching mechanism 70 based on a shift operation of the vehicle. In the present example embodiment, the electric actuator 10 drives the switching mechanism 70 by moving the movable portion 70a in the width direction (Y-axis direction) via the coupling shaft 80, and switch the park lock gear 6 between the locked state and the unlocked state. To be more specific, the electric actuator 10 rotates the detent plate 71 around the central axis J1 orthogonal or substantially orthogonal to the plate surface 71f, and changes the contact position P of the plate spring member 76 including the contact portion 76b that contacts the outer peripheral edge 71a. As illustrated in FIG. 4, the electric actuator 10 includes a case 10A, a motor 20, a speed reducer 30, an output shaft 46, a first bearing 51, a second bearing 52, a third bearing 53, a controller 90, a rotation sensor 95, a sensor magnet 45, and a current sensor 96. The first bearing 51, the second bearing 52, and the third bearing 53 are, for example, ball bearings.

The case 10A accommodates the various components of the electric actuator 10, including the motor 20, the speed reducer 30 and the output shaft 46. The case 10A includes a case body 11 and a lid member 12. The case body 11 has a cylindrical shape centered on the central axis J1. The case body 11 includes an opening 11h that opens to the one side (+X side) in the axial direction. The case body 11 includes a first accommodation portion 11a and a second accommodation portion 11b.

The first accommodation portion 11a is a portion of the case body 11 on the other side (−X side) in the axial direction. The first accommodation portion 11a includes a bottom plate portion 11c located on the other side in the axial direction and a peripheral wall portion 11d extending from a radially outer edge of the bottom plate portion 11c to the one side in the axial direction. The bottom plate portion 11c is provided with a hole portion 11e penetrating the bottom plate portion 11c in the axial direction. The hole portion 11e is a substantially circular hole centered on the central axis J1. A portion of the hole portion 11e on the one side (+X side) in the axial direction constitutes a first bearing holding portion 11f that holds the first bearing 51. The first bearing 51 is held by the first bearing holding portion 11f.

The second accommodation portion 11b is a portion of the case body 11 on the one side (+X side) in the axial direction. The second accommodation portion 11b is connected to the first accommodation portion 11a in the axial direction. The second accommodation portion 11b has a tubular shape that opens to the one side in the axial direction. A step including a stepped surface 11g facing one side in the axial direction is provided on the inner peripheral surface of the second accommodation portion 11b.

The lid member 12 is fixed to an end portion of the case body 11 on the one side (+X side) in the axial direction. The lid member 12 closes the opening 11h of the case body 11 from the one side in the axial direction. The lid member 12 includes a lid body portion 12a that closes the opening 11h from the one side in the axial direction, and a second bearing holding portion 12b that protrudes from the lid body portion 12a to the other side in the axial direction. The second bearing holding portion 12b has a cylindrical shape centered on the central axis J1 and opens to the other side (−X side) in the axial direction. The second bearing 52 is held on an inner peripheral surface of the second bearing holding portion 12b.

The motor 20 is, for example, a three phase brushless DC motor. The motor 20 rotates the output shaft 46 around the central axis J1. The motor 20 includes a rotor 21 and a stator 22. The rotor 21 is rotatable about the central axis J1. The rotor 21 includes a motor shaft 23, a rotor core 24a, and a magnet 24b. The motor shaft 23 is rotatable about the central axis J1. The motor shaft 23 has a substantially cylindrical shape extending in the axial direction centered on the central axis J1. The motor shaft 23 is a hollow shaft. The motor shaft 23 opens to both sides in the axial direction. The motor shaft 23 extends across the inside of the first accommodation portion 11a and the inside of the second accommodation portion 11b. The motor shaft 23 includes a body portion 23a and an eccentric shaft portion 23b.

The body portion 23a is a portion of the motor shaft 23 on the one side (+X side) in the axial direction. The rotor core 24a is fixed to an outer peripheral surface of the body portion 23a. An end portion of the body portion 23a on the one side in the axial direction is disposed inside the second accommodation portion 11b. A portion of the body portion 23a other than the end portion on the one side in the axial direction is disposed inside the first accommodation portion 11a.

The eccentric shaft portion 23b is a portion of the motor shaft 23 on the other side (−X side) in the axial direction. The eccentric shaft portion 23b is connected to the body portion 23a in the axial direction. The eccentric shaft portion 23b is disposed inside the first accommodation portion 11a. The eccentric shaft portion 23b is disposed on the other side in the axial direction with respect to the rotor core 24a. When viewed in the axial direction, the inner peripheral surface of the eccentric shaft portion 23b has a circular shape centered on the central axis J1. When viewed in the axial direction, the outer peripheral surface of the eccentric shaft portion 23b has a circular shape centered on an eccentric axis J2 that is eccentric with respect to the central axis J1. The eccentric axis J2 is an imaginary axis parallel to the central axis J1. An inner ring of the third bearing 53 is fitted and fixed to an outer peripheral surface of the eccentric shaft portion 23b. As a result, the third bearing 53 is fixed to the motor shaft 23. The eccentric shaft portion 23b eccentrically rotates with the rotation of the rotor 21 around the central axis J1. That is, the motor 20 includes the eccentric shaft portion 23b that rotates eccentrically.

The rotor core 24a has an annular shape centered on the central axis J1. The rotor core 24a is disposed inside the first accommodation portion 11a. The rotor core 24a is fixed to an outer peripheral surface of the body portion 23a. The magnet 24b is fixed to an outer peripheral surface of the rotor core 24a. In the present example embodiment, a plurality of magnets 24b are disposed at intervals in the circumferential direction.

The stator 22 is disposed to face the rotor 21 in the radial direction. The stator 22 is disposed radially outside of the rotor 21 with a gap between the stator 22 and the rotor 21. The stator 22 is disposed inside the first accommodation portion 11a. The stator 22 includes an annular stator core 22a surrounding the rotor core 24a from the outside in the radial direction, an insulator 22b attached to the stator core 22a, and a plurality of coil portions 22c attached to the stator core 22a via the insulator 22b. An outer peripheral surface of the stator core 22a is fixed to an inner peripheral surface of the peripheral wall portion 11d. Thus, the stator 22 is fixed to the case 10A.

The speed reducer 30 is disposed inside the first accommodation portion 11a. The speed reducer 30 is disposed on the other side (−X side) in the axial direction of the rotor core 24a and the stator 22. The speed reducer 30 is coupled to the motor shaft 23 and the output shaft 46. The speed reducer 30 decelerates the rotation of the motor 20 and transmits the decelerated rotation to the output shaft 46 to rotate the output shaft 46 around the central axis J1. The speed reducer 30 includes an external gear 31, an internal gear 32, a flange portion 42, and a plurality of protruding portions 43.

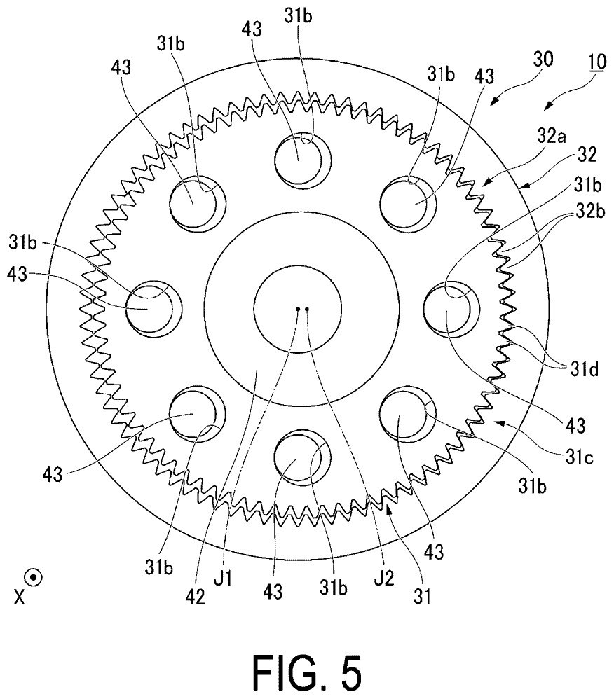

The external gear 31 has an annular shape centered on the eccentric axis J2. The external gear 31 is fitted to an outer ring of the third bearing 53. The external gear 31 is coupled to the eccentric shaft portion 23b of the motor shaft 23 via the third bearing 53. As a result, the rotation of the motor shaft 23 is transmitted to the external gear 31. The external gear 31 is rotatable about the eccentric axis J2 relative to the motor shaft 23. As illustrated in FIG. 5, the speed reducer 30 of the present example embodiment is an inscribed speed reducer. In the present specification, the “inscribed speed reducer” means a speed reducer that includes the external gear 31 and the internal gear 32 and decelerates rotation when a place where the external gear 31 and the internal gear 32 mesh with each other moves in the circumferential direction.

The external gear 31 includes a plurality of through-hole portions 31b and an external gear portion 31c. In the present example embodiment, each of the plurality of through-hole portions 31b is a hole penetrating the external gear 31 in the axial direction. When viewed in the axial direction, each of the plurality of through-hole portions 31b has a circular shape. The plurality of through-hole portions 31b are disposed to surround the central axis J1. In the present example embodiment, eight through-hole portions 31b are provided. The external gear portion 31c is provided along the outer peripheral surface of the external gear 31. The external gear portion 31c is configured by a plurality of tooth portions 31d disposed along the outer peripheral surface of the external gear 31. The tooth profile of the plurality of tooth portions 31d of the external gear 31 is, for example, an involute tooth profile.

The internal gear 32 is disposed outside the external gear 31 in the radial direction. The internal gear 32 surrounds the external gear 31 from the outside in the radial direction. The internal gear 32 has an annular shape centered on the central axis J1. As illustrated in FIG. 4, the outer peripheral surface of the internal gear 32 is fixed to the inner peripheral surface of the peripheral wall portion 11d. Thus, the internal gear 32 is fixed to the case 10A. As illustrated in FIG. 5, the internal gear 32 includes an internal gear portion 32a.

A portion of the internal gear portion 32a meshes with a portion of the external gear portion 31c. The internal gear portion 32a is provided along the inner peripheral surface of the internal gear 32. The internal gear portion 32a is configured by a plurality of tooth portions 32b disposed along the inner peripheral surface of the internal gear 32. The tooth profile of the plurality of tooth portions 32b of the internal gear 32 is, for example, an involute tooth profile.

As illustrated in FIG. 4, the flange portion 42 is disposed on the other side (−X side) of the external gear 31 in the axial direction. The flange portion 42 is disposed at an interval from the external gear 31 in the axial direction. The flange portion 42 has an annular shape centered on the central axis J1. The flange portion 42 is fixed to a portion of the output shaft 46 on the other side in the axial direction with respect to the motor shaft 23. The flange portion 42 is provided with a plurality of protruding portions 43.

In the present example embodiment, each of the plurality of protruding portions 43 has a columnar shape protruding from the flange portion 42 to the one side (+X side) in the axial direction. In the present example embodiment, the plurality of protruding portions 43 and the flange portion 42 are portions of the same single member. As illustrated in FIG. 5, the outside diameter of each of the plurality of protruding portions 43 is smaller than the inside diameter of each of the plurality of through-hole portions 31b. The plurality of protruding portions 43 are disposed to surround the central axis J1. In the present example embodiment, eight protruding portions 43 are provided. As illustrated in FIG. 4, each of the plurality of protruding portions 43 is inserted into the corresponding one of the plurality of through-hole portions 31b from the other side (−X side) in the axial direction. As illustrated in FIG. 5, each protruding portion 43 supports the external gear 31 so as to be swingable around the central axis J1 via the inner side surface of the through-hole portion 31b.

The output shaft 46 outputs the driving force of the electric actuator 10 to the switching mechanism 70 via the coupling shaft 80. As illustrated in FIG. 4, the output shaft 46 extends in the axial direction centered on the central axis J1. The output shaft 46 is rotatable around the central axis J1. The rotation of the motor shaft 23 is transmitted to the output shaft 46 via the speed reducer 30. The output shaft 46 is passed through the inside of the motor shaft 23 in the axial direction. The output shaft 46 protrudes from the motor shaft 23 toward both sides in the axial direction. The output shaft 46 and the flange portion 42 may be portions of the same single member.

The output shaft 46 includes an output shaft body 41 and an attachment member 44 fixed to the outer peripheral surface of the output shaft body 41. The output shaft body 41 extends in the axial direction. The output shaft body 41 is rotatably supported around the central axis J1 by the first bearing 51 and the second bearing 52. The output shaft body 41 includes a coupling portion 41a and an extending portion 41b.

The coupling portion 41a is a portion on the other side (−X side) in the axial direction of the output shaft body 41. The coupling portion 41a has a cylindrical shape extending in the axial direction centered on the central axis J1. The coupling portion 41a opens to the other side in the axial direction. An end portion of the coupling portion 41a on the other side in the axial direction is inserted into the hole portion 11e. An end portion of the coupling portion 41a on the one side (+X side) in the axial direction is inserted into the eccentric shaft portion 23b. The coupling portion 41a is supported by the first bearing 51 so as to be rotatable about the central axis J1.

The end portion 81 of the coupling shaft 80 can be inserted into the coupling portion 41a from the other side (−X side) in the axial direction. When the plurality of spline grooves provided on the outer peripheral surface of the end portion 81 of the coupling shaft 80 are fitted to the plurality of spline grooves provided on the inner peripheral surface of the coupling portion 41a, the coupling portion 41a and the coupling shaft 80 are coupled to each other. As a result, the output shaft 46 is coupled to the detent plate 71, which is the first portion, via the coupling shaft 80. The rotation of the output shaft 46 is transmitted to the detent plate 71 via the coupling shaft 80. Accordingly, the electric actuator 10 drives the switching mechanism 70.

The extending portion 41b is a portion on the one side (+X side) in the axial direction of the output shaft body 41. The extending portion 41b has a columnar shape extending in the axial direction centered on the central axis J1. The extending portion 41b is connected to the coupling portion 41a in the axial direction. The extending portion 41b is passed through the inside of the motor shaft 23 in the axial direction. A portion of the extending portion 41b on the one side in the axial direction protrudes to the one side in the axial direction with respect to the motor shaft 23. An end portion of the extending portion 41b on the one side in the axial direction is supported by the second bearing 52 so as to be rotatable around the central axis J1.

In the present example embodiment, the outside diameter of the extending portion 41b is smaller than the inside diameter of the body portion 23a of the motor shaft 23. The extending portion 41b is in clearance fit with the inside of the body portion 23a. A gap between the extending portion 41b and the body portion 23a in the radial direction is small enough to support the motor shaft 23 by the extending portion 41b such that the motor shaft 23 is rotatable about the central axis J1. Therefore, the motor shaft 23 is supported by the case 10A via the output shaft 46, the first bearing 51 and the second bearing 52. In this manner, the radial movement of the motor shaft 23 relative to the case 10A can be limited.

The attachment member 44 is fixed to a portion of the outer peripheral surface of the extending portion 41b on the one side (+X side) in the axial direction with respect to the motor shaft 23. The attachment member 44 includes a fixed cylinder portion 44a and an annular portion 44b. The fixed cylinder portion 44a has a cylindrical shape that is centered on the central axis J1 and opens on both sides in the axial direction. The fixed cylinder portion 44a is fixed to the outer peripheral surface of the extending portion 41b. The annular portion 44b has a substantially annular plate shape extending radially outward from an end portion of the fixed cylinder portion 44a on the other side (−X side) in the axial direction.

The sensor magnet 45 has an annular shape surrounding the central axis J1. The sensor magnet 45 is fixed to the outer peripheral surface of the fixed cylinder portion 44a. A radially outer edge portion of the sensor magnet 45 is located radially outward of the annular portion 44b, and faces the rotation sensor 95 in the axial direction.

In the axial direction, a washer 61 is disposed between the end portion on the other side (−X side) in the axial direction of the body portion 23a of the motor shaft 23 and the end portion on the one side (+X side) in the axial direction of the coupling portion 41a of the output shaft 46. The washer 61 has an annular plate shape surrounding the extending portion 41b. Plate surfaces of the washer 61 face in the axial direction. The washer 61 is in contact with each of the body portion 23a and the coupling portion 41a in the axial direction. In the axial direction, the washer 62 is disposed between the end portion of the body portion 23a on the one side in the axial direction and the annular portion 44b. The washer 62 has an annular plate shape surrounding the extending portion 41b. Plate surfaces of the washer 62 face in the axial direction. The washer 62 is in contact with each of the body portion 23a and the annular portion 44b in the axial direction. The washer 61 and the washer 62 are, for example, slip washers.

When electric power is supplied to the motor 20 and the motor shaft 23 rotates about the central axis J1, the eccentric shaft portion 23b revolves in the circumferential direction about the central axis J1. The revolution of the eccentric shaft portion 23b is transmitted to the external gear 31 via the third bearing 53. The external gear 31 revolves around the central axis J1 while the contact position between the inner peripheral surface of the through-hole portion 31b and the outer peripheral surface of the protruding portion 43 changes. When the external gear 31 revolves around the central axis J1, a position at which the external gear portion 31c of the external gear 31 and the internal gear portion 32a of the internal gear 32 mesh with each other changes in the circumferential direction. As a result, the driving force of the motor shaft 23 is transmitted to the internal gear 32 via the external gear 31.

As described above, the internal gear 32 is fixed to the case 10A. Therefore, the external gear 31 rotates around the eccentric axis J2 by a reactive force of the driving force transmitted to the internal gear 32. At this time, the rotation of the external gear 31 is decelerated with respect to the rotation of the motor shaft 23. The rotation of the external gear 31 around the eccentric axis J2 is transmitted to the flange portion 42 via the inner side surface of the through-hole portion 31b and the protruding portion 43, and the flange portion 42 rotates around the central axis J1. As described above, since the output shaft 46 is fixed to the flange portion 42, the output shaft 46 rotates around the central axis J1 together with the flange portion 42. That is, the flange portion 42 transmits the rotation of the external gear 31 to the output shaft 46. In this manner, the rotation of the motor shaft 23 is transmitted to the output shaft 46 via the speed reducer 30.

The electric actuator 10 includes a function of holding the rotation angle θa of the output shaft 46 when electric power is not supplied to the motor 20, that is, a self-holding function. The self-holding function is implemented, for example, by mechanically locking the rotation of the output shaft 46 in a state where no electric power is supplied to the motor 20. For example, the speed reduction device 4 may have a structure including the self-holding function, or a mechanism for adding the self-holding function may be separately provided. The electric actuator 10 may have a self-holding function using cogging torque. Any known self-holding function can be adopted as the self-holding function mounted on the electric actuator 10.

The controller 90 controls the motor 20. In the present example embodiment, the controller 90 controls the motor 20 by pulse width modulation (PWM) control. The controller 90 is disposed on the one side (+X side) of the stator 22 in the axial direction. The controller 90 includes a substrate 91. The substrate 91 is fixed to the stepped surface 11g of the case 10A. The substrate 91 has a plate shape extending in the radial direction. The substrate 91 is provided with a through-hole 91a penetrating the substrate 91 in the axial direction. The extending portion 41b of the output shaft 46 passes through the through-hole 91a in the axial direction.

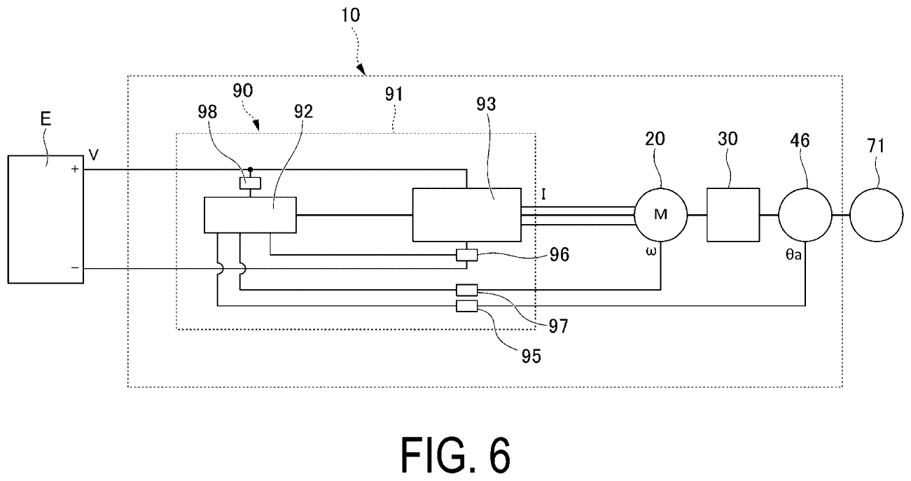

As illustrated in FIG. 6, the controller 90 includes a calculation unit 92 and an inverter circuit unit 93. Although not illustrated, the inverter circuit unit 93 is configured by a plurality of switching elements. The inverter circuit unit 93 supplies the current I to the motor 20. More specifically, the inverter circuit unit 93 supplies the three-phase current I to the plurality of coil portions 22c of the stator 22. The inverter circuit unit 93 is controlled by the calculation unit 92.

The calculation unit 92 is a portion of the controller 90 that can execute obtaining control, which will be described below. The calculation unit 92 is a processor such as a central processing unit (CPU). The calculation unit 92 inputs a pulse signal used for pulse width modulation control to the inverter circuit unit 93 to drive the inverter circuit unit 93. More specifically, the calculation unit 92 inputs a pulse signal to each switching element of the inverter circuit unit 93 to switch each switching element between an ON state and an OFF state. The calculation unit 92 receives an output signal of the current sensor 96 mounted on the substrate 91. The current sensor 96 detects a three-phase current I supplied to the motor 20 by the inverter circuit unit 93. The calculation unit 92 receives an output signal of the angular velocity sensor 97 mounted on the substrate 91. The angular velocity sensor 97 detects a rotational angular velocity ω of the motor shaft 23 of the motor 20. A sensor that detects the rotation angle of the motor shaft 23 may be provided instead of the angular velocity sensor 97. In this case, the calculation unit 92 may detect the rotational angular velocity ω of the motor shaft 23 based on the output of the sensor. Further, the calculation unit 92 may detect a counter electromotive voltage generated in the motor 20 by a sensor that detects a voltage applied from the inverter circuit unit 93 to the motor 20, and may calculate the rotational angular velocity ω of the motor shaft 23 based on the counter electromotive voltage.

The calculation unit 92 receives an output signal of the voltage sensor 98 mounted on the substrate 91. The voltage sensor 98 detects an input voltage applied from an external power supply E that supplies power to the controller 90. The calculation unit 92 receives an output signal of the rotation sensor 95 mounted on the substrate 91. The rotation sensor 95 detects a rotation angle θa of the output shaft 46. In the present example embodiment, the rotation sensor 95 is a magnetic sensor. The rotation sensor 95 is, for example, a Hall element such as a Hall IC. The rotation sensor 95 detects the rotation of the sensor magnet 45 by detecting the magnetic field of the sensor magnet 45. In this manner, the rotation sensor 95 detects the rotation angle of the output shaft 46. The rotation sensor 95 may be any sensor as long as it can detect the rotation angle θa of the output shaft 46.

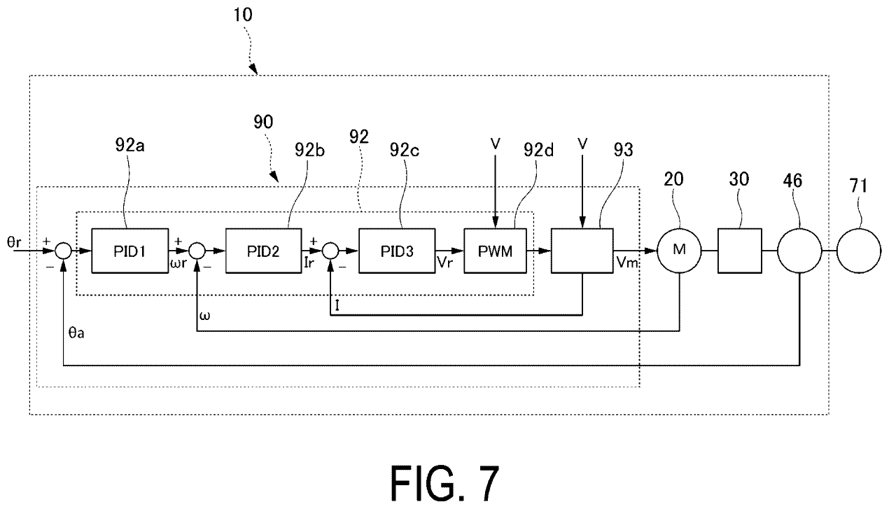

As illustrated in FIG. 7, the calculation unit 92 includes an angle controller 92a, an angular velocity controller 92b, a current controller 92c, and a pulse generation unit 92d. The angle controller 92a executes a proportional-integral-derivative (PID) control in which the rotation angle θa of the output shaft 46 is fed back. The angle controller 92a receives a value obtained by subtracting the current rotation angle θa from a command value θr for the rotation angle θa. The command value θr is input from a host device of the electric actuator 10. The host device may be a control device mounted on the drive device 1 or may be a control device that controls each portion of the vehicle. The angle controller 92a outputs a command value ωr for the rotational angular velocity ω. The angular velocity controller 92b executes the PID control in which the rotational angular velocity ω of the motor shaft 23 is fed back. The angular velocity controller 92b receives a value obtained by subtracting the current rotational angular velocity ω from the command value ωr output from the angle controller 92a. The angular velocity controller 92b outputs a command value Ir for the three-phase current I. The current controller 92c executes the PID control in which the three-phase current I is fed back. The current controller 92c receives a value obtained by subtracting the present current I from the command value Ir output from the angular velocity controller 92b. The current controller 92c outputs the command value Vr for the output voltage Vm applied to the motor 20 to the pulse generation unit 92d. The pulse generation unit 92d generates pulse signal to be input to the inverter circuit unit 93, based on the input command value Vr. In the pulse width modulation control, the duty cycle of the pulse signal input to the inverter circuit unit 93 periodically changes within a range from 0 to the maximum value appropriately set based on the phase information of the motor 20.

The controller 90 can execute obtaining control in which the rotation angle θa of the output shaft 46 when the contact position P corresponds to the bottom portion of the valley portion 79 is obtained to be the bottom position rotation angle. The obtaining control is executed before the electric actuator 10 is used for the first time. In the present example embodiment, the obtaining control is performed after the electric actuator 10 is attached to the switching mechanism 70 and before the drive device 1 is used for the first time. The obtaining control is learning control included in a learning method in which the electric actuator 10 self-learns the rotation angle θa of the output shaft 46. In the present example embodiment, the controller 90 executes the obtaining control by the calculation unit 92.

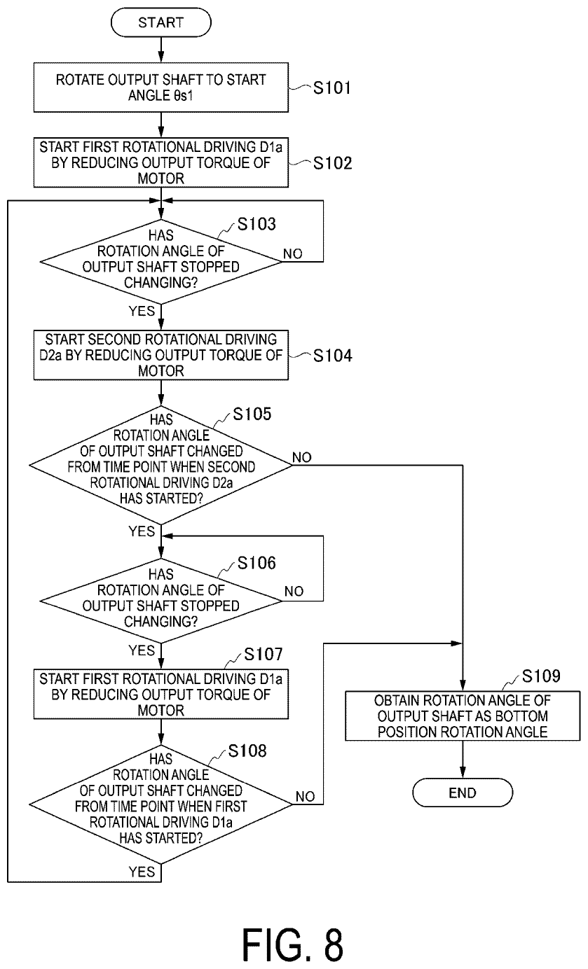

In the present example embodiment, the controller 90 executes the obtaining control for each of the three valley portions 79. FIG. 8 is a flowchart illustrating an example of obtaining control for the valley portion 79a. As illustrated in FIG. 8, in the obtaining control for the valley portion 79a, the controller 90 rotates the output shaft 46 to the start angle θs1 (step S101). The start angle θs1 is an angle stored in advance in the controller 90 as the rotation angle θa when the contact position P corresponds to the bottom portion 79f of the valley portion 79a. Ideally, the contact portion 76b comes into contact with the bottom portion 79f when the rotation angle θa of the output shaft 46 reaches the start angle θs1 stored in advance. However, in reality, due to an assembly tolerance of the electric actuator 10, an assembly tolerance of the switching mechanism 70, an assembly tolerance between the electric actuator 10 and the switching mechanism 70, and the like, the contact portion 76b contacts the outer peripheral edge 71a of the detent plate 71 at a position that is shifted from the bottom portion 79f even when the rotation angle θa of the output shaft 46 is set to the start angle θs1. Therefore, in order to learn the rotation angle θa when the contact portion 76b contacts the bottom portion 79f, the electric actuator 10 needs to execute the obtaining control. Although the contact position P of the contact portion 76b at the start angle θs1 is shifted with respect to the bottom portion 79f due to the above-described tolerances and the like, the shift is not so large as to be shifted from the valley portion 79a. That is, the start angle θs1 is an angle at which the contact position P corresponds to the valley portion 79a.

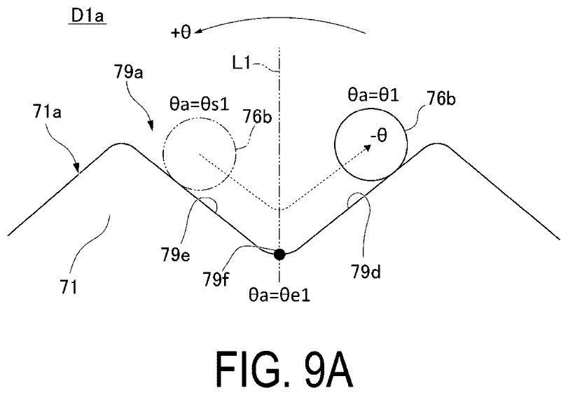

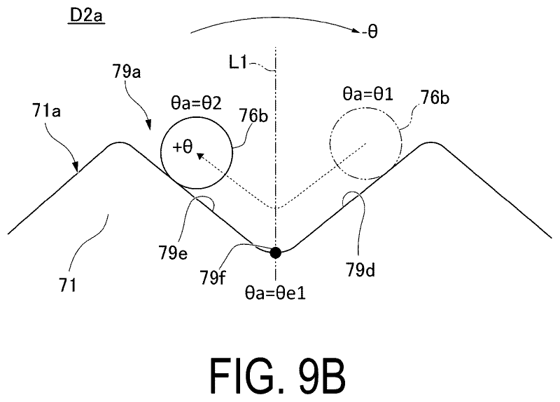

In the description of the flowchart of FIG. 8, a case where the contact portion 76b contacts the second inclined surface 79e when the output shaft 46 is rotated to the start angle θs1 as illustrated in FIG. 9A will be described. When the output shaft 46 is rotated to the start angle θs1, the contact portion 76b may also contact the first inclined surface 79d. In FIG. 9A, the contact portion 76b when the rotation angle θa of the output shaft 46 reaches the start angle θs1 is indicated by a two dot chain line.

As illustrated in FIG. 8, after rotating the output shaft 46 to the start angle θs1, the controller 90 starts the first rotational driving D1a by reducing the output torque Tm of the motor 20 (step S102). The first rotational driving D1a is a drive for rotating the output shaft 46 to the one side (+θ side) in the circumferential direction around the central axis J1. The output torque Tm of the motor 20 in the first rotational driving D1a is smaller than the output torque Tm at which the contact portion 76b can climb over the first inclined surface 79d. That is, the obtaining control includes setting the output torque Tm of the motor 20 in the first rotational driving D1a to be smaller than the output torque Tm at which the contact portion 76b can climb over the first inclined surface 79d. In the present example embodiment, the controller 90 adjusts the output torque Tm of the motor 20 by adjusting the maximum value of the duty cycle in the pulse signal of the pulse width modulation control generated by the pulse generation unit 92d. As the maximum value of the duty cycle in the pulse signal of the pulse width modulation control increases, the output torque Tm of the motor 20 increases. As the maximum value of the duty cycle in the pulse signal of the pulse width modulation control decreases, the output torque Tm of the motor 20 decreases.

As illustrated in FIG. 9A, when the first rotational driving D1a is performed to rotate the output shaft 46 to the one side (+θ side) in the circumferential direction, the contact portion 76b moves to the other side (−θ side) in the circumferential direction relative to the detent plate 71. When the first rotational driving D1a is executed, the contact portion 76b, which has been in contact with the second inclined surface 79e in the example of FIG. 9A, moves down the second inclined surface 79e, passes through the bottom portion 79f, and then moves up the first inclined surface 79d. Here, as described above, the output torque Tm of the motor 20 in the first rotational driving D1a is smaller than the output torque Tm at which the contact portion 76b can climb over the first inclined surface 79d. Therefore, when the first rotational driving D1a is executed, after the contact portion 76b starts to climb up the first inclined surface 79d, there is a timing at which the contact portion 76b cannot climb up the first inclined surface 79d and the output shaft 46 stops rotating. Specifically, when the electric actuator 10 is no longer able to rotate the detent plate 71 in the circumferential direction against the resilient force by which the plate spring body portion 76a presses the contact portion 76b against the outer peripheral edge 71a, the output shaft 46 stops rotating.

As illustrated in FIG. 8, after starting the first rotational driving D1a, the controller 90 determines whether the rotation angle θa of the output shaft 46 has stopped changing (step S103). In the present example embodiment, the controller 90 obtains the rotation angle θa of the output shaft 46, based on the output of the rotation sensor 95, and performs various determinations. In step S103, the controller 90 determines that the rotation angle θa of the output shaft 46 does not change in the first rotational driving D1a, when the rotation angle θa of the output shaft 46 does not change at all during the execution of the first rotational driving D1a and when the rotation angle θa of the output shaft 46 does not substantially change during the execution of the first rotational driving D1a.

The case where the rotation angle θa of the output shaft 46 does not substantially change includes, for example, a case where, even if the rotation angle θa of the output shaft 46 changes, an amount of the change is small enough to fall within a range of a degree generated by elastic deformation of each member, a variation of the detection value by the rotation sensor 95, and the like, and the output shaft 46 does not substantially rotate. The controller 90 stores a first predetermined value determined based on the maximum value of a slight change amount of the rotation angle θa that can occur when the output shaft 46 does not substantially rotate. The first predetermined value is a value equal to or greater than the maximum value of the slight change amount of the rotation angle θa that can occur when the output shaft 46 is not substantially rotating. In step S103, when a state in which the amount of change in the rotation angle θa remains equal to or less than the first predetermined value continues for the first predetermined time during the execution of the first rotational driving D1a, the controller 90 determines that the rotation angle θa of the output shaft 46 has stopped changing (step S103: YES). The first predetermined time is appropriately determined based on the rotation speed of the output shaft 46 when the first rotational driving D1a is executed. The first predetermined time is, for example, about several seconds or less.

When the controller 90 determines that the rotation angle θa of the output shaft 46 is changing in step S103 (step S103: NO), the controller 90 continues the first rotational driving D1a. When the controller 90 determines that the rotation angle θa of the output shaft 46 does not change in step S103 (step S103: YES), the controller 90 ends the first rotational driving D1a and starts the second rotational driving D2a by reducing the output torque Tm of the motor 20 (step S104). That is, the obtaining control includes switching from the first rotational driving D1a to the second rotational driving D2a when it is determined that the output shaft 46 has stopped in the first rotational driving D1a.

FIG. 9A illustrates an example in which the output shaft 46 does not rotate when the rotation angle θa reaches the angle θ1 by the first rotational driving D1a. In the example in FIG. 9A, the angle θ1 is a rotation angle θa whose difference from the bottom position rotation angle θe1, which is the rotation angle θa when the contact portion 76b comes into contact with the bottom portion 79f, is larger than the start angle θs1. However, depending on the position of the contact portion 76b at the start angle θs1, the difference between the angle θ1 and the bottom position rotation angle θe1 may be equal to or smaller than the difference between the start angle θs1 and the bottom position rotation angle θe1.

The second rotational driving D2a is a drive for rotating the output shaft 46 to the other side (−θ side) in the circumferential direction around the central axis J1. The output torque Tm of the motor 20 in the second rotational driving D2a is smaller than the output torque Tm at which the contact portion 76b can climb over the second inclined surface 79e. That is, the obtaining control includes setting the output torque Tm of the motor 20 in the second rotational driving D2a to be smaller than the output torque Tm at which the contact portion 76b can climb over the second inclined surface 79e. In the present example embodiment, the output torque Tm of the motor 20 in the second rotational driving D2a is smaller than the output torque Tm of the motor 20 in the first rotational driving D1a performed immediately before the second rotational driving D2a. That is, in the present example embodiment, the obtaining control includes setting the output torque Tm of the motor 20 in the second rotational driving D2a to be smaller than the output torque Tm of the motor 20 in the first rotational driving D1a performed immediately before the second rotational driving D2a.

As illustrated in FIG. 9B, when the second rotational driving D2a is performed to rotate the output shaft 46 to the other side (−θ side) in the circumferential direction, the contact portion 76b moves to the one side (+θ side) in the circumferential direction relative to the detent plate 71. When the second rotational driving D2a is executed, the contact portion 76b, which has been in contact with the first inclined surface 79d by the first rotational driving D1a, moves down the first inclined surface 79d, passes through the bottom portion 79f, and then moves up the second inclined surface 79e. Here, as described above, the output torque Tm of the motor 20 in the second rotational driving D2a is smaller than the output torque Tm at which the contact portion 76b can climb over the second inclined surface 79e. Therefore, when the second rotational driving D2a is executed, similar to when the first rotational driving D1a is executed, after the contact portion 76b starts moving up the second inclined surface 79e, there is a timing at which the contact portion 76b cannot climb up the second inclined surface 79e and the output shaft 46 stops rotating.

As illustrated in FIG. 8, in the present example embodiment, after the second rotational driving D2a is started, the controller 90 determines whether the rotation angle θa of the output shaft 46 has changed from the time point when the second rotational driving D2a is started (step S105). In step S105, when the rotation angle θa of the output shaft 46 does not change at all even if the second rotational driving D2a is started, and when the rotation angle θa of the output shaft 46 does not substantially change even if the second rotational driving D2a is started, the controller 90 determines that the rotation angle θa of the output shaft 46 has not changed from the time point when the second rotational driving D2a is started.

The case where the rotation angle θa of the output shaft 46 does not substantially change even if the second rotational driving D2a is started includes, for example, a case where, even if the rotation angle θa of the output shaft 46 changes after the second rotational driving D2a is started, an amount of change is equal to or less than the above-described first predetermined value, and the output shaft 46 does not substantially rotate. In step S105, when the amount of change in the rotation angle θa remains equal to or less than the first predetermined value even after the second predetermined time has elapsed from the start of the second rotational driving D2a, the controller 90 determines that the rotation angle θa of the output shaft 46 has not changed from the start of the second rotational driving D2a (step S105: NO). In step S105, if the amount of change in the rotation angle θa is larger than the first predetermined value when the second predetermined time has elapsed from the start of the second rotational driving D2a, the controller 90 determines that the rotation angle θa of the output shaft 46 has changed from the start of the second rotational driving D2a (step S105: YES). The second predetermined time is appropriately determined based on the rotation speed of the output shaft 46 when the second rotational driving D2a is executed. The second predetermined time may be the same as or different from the first predetermined time described above. The second predetermined time is, for example, about several seconds or less.

When the controller 90 determines that the rotation angle θa of the output shaft 46 has changed since the second rotational driving D2a has started in step S105 (step S105: YES), the controller 90 continues the second rotational driving D2a and determines whether the rotation angle θa of the output shaft 46 has stopped changing (step S106). In step S106, when a state in which the amount of change in the rotation angle θa remains equal to or less than the above-described first predetermined value continues for a third predetermined time during execution of the second rotational driving D2a, the controller 90 determines that the rotation angle θa of the output shaft 46 has stopped changing (step S106: YES). The third predetermined time is appropriately determined based on the rotation speed of the output shaft 46 when the second rotational driving D2a is executed. The third predetermined time may be the same as or different from the first predetermined time and the second predetermined time described above. The third predetermined time is, for example, about several seconds or less.

When the controller 90 determines that the rotation angle θa of the output shaft 46 is changing in step S106 (step S106: NO), the controller 90 continues the second rotational driving D2a. When the controller 90 determines that the rotation angle θa of the output shaft 46 does not change in step S106 (step S106: YES), the controller 90 reduces the output torque Tm of the motor 20 and starts the first rotational driving D1a again after finishing the second rotational driving D2a (step S107). That is, the obtaining control includes switching from the second rotational driving D2a to the first rotational driving D1a when it is determined that the rotation angle θa of the output shaft 46 does not change in the second rotational driving D2a.

FIG. 9B illustrates an example in which the output shaft 46 does not rotate when the rotation angle θa reaches the angle θ2 by the second rotational driving D2a. In the present example embodiment, the first inclined surface 79d and the second inclined surface 79e are disposed in line symmetry with respect to an imaginary line L1 passing through the bottom portion 79f and extending in the radial direction when viewed in the axial direction. The output torque Tm of the motor 20 in the second rotational driving D2a is smaller than the output torque Tm of the motor 20 in the first rotational driving D1a. Therefore, the angle θ2 at which the output shaft 46 stops rotating in the second rotational driving D2a is closer to the bottom position rotation angle θe1 than the angle θ1 at which the output shaft 46 stops rotating at the first rotational driving D1a performed immediately before the second rotational driving D2a.

The output torque Tm of the motor 20 in the first rotational driving D1a, which is started again in step S107, is smaller than the output torque Tm of the motor 20 in the previous first rotational driving D1a. That is, the obtaining control includes reducing the output torque Tm of the motor 20 in the first rotational driving D1a each time the first rotational driving D1a is performed. The output torque Tm of the motor 20 in the first rotational driving D1a, which is started again in step S107, is smaller than the output torque Tm of the motor 20 in the second rotational driving D2a, which is performed immediately before. That is, the obtaining control includes setting the output torque Tm of the motor in the first rotational driving D1a to be smaller than the output torque Tm of the motor 20 in the second rotational driving D2a performed immediately before the first rotational driving D1a.

As illustrated in FIG. 8, after the first rotational driving D1a is started again, the controller 90 determines whether the rotation angle θa of the output shaft 46 has changed from the time point when the first rotational driving D1a is started (step S108). In step S108, when the amount of change in the rotation angle θa remains equal to or less than the above-described first predetermined value even after the fourth predetermined time has elapsed from the start of the first rotational driving D1a, the controller 90 determines that the rotation angle θa of the output shaft 46 has not changed from the start of the first rotational driving D1a (step S108: NO). In step S108, if the amount of change in the rotation angle θa is larger than the first predetermined value when the fourth predetermined time has elapsed from the start of the first rotational driving D1a, the controller 90 determines that the rotation angle θa of the output shaft 46 has changed from the start of the first rotational driving D1a (step S108: YES). The fourth predetermined time is appropriately determined based on the rotation speed of the output shaft 46 when the first rotational driving D1a is executed. The fourth predetermined time may be the same as or different from the first predetermined time to the third predetermined time described above. The fourth predetermined time is, for example, about several seconds or less.

When the controller 90 determines that the rotation angle θa of the output shaft 46 has changed from the time point when the first rotational driving D1a is started in step S108 (step S108: YES), the controller 90 executes step S103 again. When the controller 90 determines that the rotation angle θa of the output shaft 46 does not change again in step S103, the controller 90 starts the second rotational driving D2a again. The output torque Tm of the motor 20 in the second rotational driving D2a, which is restarted, is smaller than the output torque Tm of the motor 20 in the second rotational driving D2a, which has been performed last time. That is, the obtaining control includes reducing the output torque of the motor 20 in the second rotational driving D2a each time the second rotational driving D2a is performed.

As described above, in the obtaining control for the valley portion 79a, the first rotational driving D1a and the second rotational driving D2a are alternately repeated. That is, the obtaining control for the valley portion 79a includes alternately repeating the first rotational driving D1a and the second rotational driving D2a from the state where the rotation angle θa of the output shaft 46 is the start angle θs1. When the controller 90 determines that the rotation angle θa of the output shaft 46 has not changed from the time point when the second rotational driving D2a is started in step S105 (step S105: NO), or when the controller 90 determines that the rotation angle θa of the output shaft 46 has not changed from the time point when the first rotational driving D1a is started in step S108 (step S108: NO), the controller 90 ends the alternate execution of the first rotational driving D1a and the second rotational driving D2a, and obtains the rotation angle θa of the output shaft 46 at that time point as the bottom position rotation angle θe1 in the valley portion 79a (step S109). That is, the obtaining control includes obtaining the rotation angle θa of the output shaft 46 as the bottom position rotation angle θe1 when the rotational driving is switched from one of the first rotational driving D1a and the second rotational driving D2a to the other rotational driving and the rotation angle θa of the output shaft 46 does not change even when the other rotational driving is executed.

The rotation angle θa obtained to be the bottom position rotation angle θe1 in step S109 is the rotation angle θa in the case where the output shaft 46 does not rotate even when the second rotational driving D2a is executed after the first rotational driving D1a is ended, or the rotation angle θa in the case where the output shaft 46 does not rotate even when the first rotational driving D1a is executed after the second rotational driving D2a is ended. In step S109, the controller 90 obtains, as the bottom position rotation angle θe1, the rotation angle θa after the power supply to the motor 20 is stopped after it is determined that the output shaft 46 is not rotating in step S105 or step S108. Thus, the obtaining control for the valley portion 79a is completed.

According to the present example embodiment, the obtaining control for the valley portion 79a includes, from a state where the rotation angle θa of the output shaft 46 is the start angle θs1 at which the contact position P becomes the valley portion 79a, alternately repeating the first rotational driving D1a for rotating the output shaft 46 to the one side in the circumferential direction around the central axis J1 and the second rotational driving D2a for rotating the output shaft to the other side in the circumferential direction around the central axis J1, setting the output torque Tm of the motor 20 in the first rotational driving D1a to be smaller than the output torque Tm at which the contact portion 76b can climb over the first inclined surface 79d, switching from the first rotational driving D1a to the second rotational driving D2a when it is determined that the output shaft 46 has stopped in the first rotational driving D1a, and reducing the output torque Tm of the motor 20 in the first rotational driving D1a each time the first rotational driving D1a is performed. Since the output torque Tm of the motor 20 is reduced each time the first rotational driving D1a is performed, the rotation angle θa at which the output shaft 46 stops rotating in the first rotational driving D1a approaches the bottom position rotation angle θe1 each time the first rotational driving D1a is performed. As a result, when the first rotational driving D1a is repeated, the contact position P of the contact portion 76b when the rotation of the output shaft 46 is stopped approaches the bottom portion 79f, and the contact position P when the rotation of the output shaft 46 is stopped finally becomes the bottom portion 79f. Therefore, the bottom position rotation angle θe1 can be accurately obtained based on the rotation angle θa of the output shaft 46 in the first rotational driving D1a. Therefore, the rotation angle θa of the output shaft 46 can be accurately learned.

Further, according to the present example embodiment, the obtaining control for the valley portion 79a includes setting the output torque Tm of the motor 20 in the second rotational driving D2a to be smaller than the output torque Tm at which the contact portion 76b can climb over the second inclined surface 79e, switching from the second rotational driving D2a to the first rotational driving D1a when it is determined that the rotation angle θa of the output shaft 46 does not change in the second rotational driving D2a, reducing the output torque Tm of the motor 20 in the second rotational driving D2a each time the second rotational driving D2a is performed, and obtaining the rotation angle θa of the output shaft 46 as the bottom position rotation angle θe1 when the rotation angle θa of the output shaft 46 does not change even if the other rotational driving is executed when one rotational driving of the first rotational driving D1a and the second rotational driving D2a is switched to the other rotational driving. Since the output torque Tm of the motor 20 is reduced each time the second rotational driving D2a is performed, the rotation angle θa at which the output shaft 46 stops rotating in the second rotational driving D2a approaches the bottom position rotation angle θe1 each time the second rotational driving D2a is performed. Therefore, even when the second rotational driving D2a is repeated, the contact position P when the rotation of the output shaft 46 is stopped approaches the bottom portion 79f, and the contact position P finally becomes the bottom portion 79f. In this case, when the contact position P corresponds to the bottom portion 79f, the output shaft 46 does not rotate even when the first rotational driving D1a is executed and the second rotational driving D2a is executed. Therefore, when the output shaft 46 does not rotate even when the second rotational driving D2a is executed after the first rotational driving D1a is executed and the output shaft 46 does not rotate, or when the output shaft 46 does not rotate even when the first rotational driving D1a is executed after the second rotational driving D2a is executed and the output shaft 46 does not rotate, it can be determined that the rotation angle θa of the output shaft 46 is the bottom position rotation angle θe1 at which the contact portion 76b contacts the bottom portion 79f. Therefore, the bottom position rotation angle θe1 can be more accurately obtained by obtaining, as the bottom position rotation angle θe1, the rotation angle θa of the output shaft 46 when it is determined that the rotation angle θa of the output shaft 46 does not change from the time point at which each rotational driving is started in the above-described steps S105 and S108. Therefore, the rotation angle θa of the output shaft 46 can be learned more accurately.

Further, according to the present example embodiment, the obtaining control for the valley portion 79a includes setting the output torque Tm of the motor 20 in the second rotational driving D2a to be smaller than the output torque Tm of the motor 20 in the first rotational driving D1a performed immediately before the second rotational driving D2a. Therefore, the rotation angle θa at which the output shaft 46 stops can be set to the bottom position rotation angle θe1 with a smaller number of times of execution of the rotational driving as compared to a case where the output torque Tm of the motor 20 in the second rotational driving D2a is set to be equal to the output torque Tm of the motor 20 in the first rotational driving D1a performed immediately before. Therefore, the time required for the obtaining control can be shortened, and the bottom position rotation angle θe1 can be quickly obtained.

According to the present example embodiment, the controller 90 executes the obtaining control in the valley portion 79a located between the valley portion 79 located closest to the one side and the valley portion 79 located closest to the other side in the circumferential direction around the central axis J1 among the three or more valley portions 79. In this manner, in the valley portion 79a provided between the valley portions 79, since it is necessary to move the contact portion 76b between the valley portions 79, it is not possible to provide an inclined surface (wall surface) over which the contact portion 76b cannot climb. Therefore, it is not possible to adopt the abutting learning control in which the bottom position rotation angle θe1 is obtained by abutting the contact portion 76b against the inclined surface of the valley portion 79a as in the related art. On the other hand, when the obtaining control of the present example embodiment for the valley portion 79a as described above is used, the first rotational driving D1a and the second rotational driving D2a are alternately executed, and the output torque Tm of the motor 20 in each rotational driving is reduced, so that the rotation angle θa at which the output shaft 46 stops rotating can be brought close to the bottom position rotation angle θe1. Therefore, the bottom position rotation angle θe1 can be accurately obtained even in the valley portion 79a having no abutting wall.

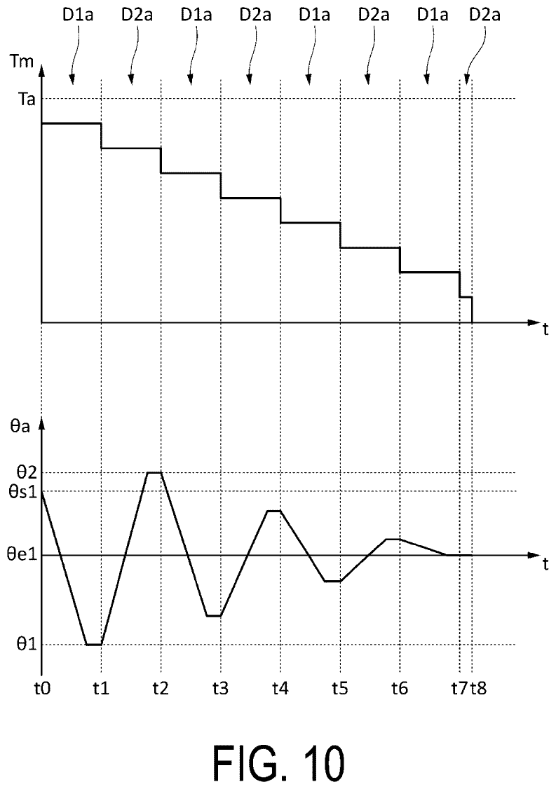

FIG. 10 is a diagram illustrating an example of a change in the output torque Tm of the motor 20 and a change in the rotation angle θa of the output shaft 46 in the obtaining control for the valley portion 79a. In the upper graph of FIG. 10, the vertical axis represents the output torque Tm, and the horizontal axis represents the time t. In the lower graph of FIG. 10, the vertical axis represents the rotation angle θa of the output shaft 46, and the horizontal axis represents the time t. In FIG. 10, the rotation angle θa at the time t0 is the start angle θs1. The first rotational driving D1a is executed from the time t0 to the time t1, from the time t2 to the time t3, from the time t4 to the time t5, and from the time t6 to the time t7. The second rotational driving D2a is executed from the time t1 to the time t2, from the time t3 to the time t4, from the time t5 to the time t6, and from the time t7 to the time t8. From the time t7 to the time t8, the second rotational driving D2a is executed, but the rotation angle θa does not change because the output shaft 46 does not rotate from the time point when the second rotational driving D2a is started. In the example of FIG. 10, the bottom position rotation angle θe1 is obtained at the time t8.

As illustrated in the lower graph of FIG. 10, the rotation angle θa approaches the bottom position rotation angle θe1 each time the first rotational driving D1a and the second rotational driving D2a are executed. As illustrated in the upper graph of FIG. 10, the output torque Tm is reduced each time the first rotational driving D1a and the second rotational driving D2a are performed. A torque Ta illustrated in the upper graph of FIG. 10 is an output torque Tm of the motor 20 when the switching mechanism 70 is driven. The torque Ta is the output torque Tm at which the contact portion 76b can climb over the first inclined surface 79d and the second inclined surface 79e, and can climb over the mountain portions 71c and 71d. The controller 90 sets the output torque Tm to the torque Ta when rotating the output shaft 46 to the start angle θs1. The output torque Tm for rotating the output shaft 46 to the start angle θs1 may be any torque as long as the output shaft 46 can be rotated to the start angle θs1. In the obtaining control for the valley portion 79a, the maximum value of the duty cycle of the pulse signal input to the inverter circuit unit 93 changes similarly to the output torque Tm illustrated in the upper graph of FIG. 10.

When the start angle θs1 is the rotation angle θa at which the contact portion 76b comes into contact with the first inclined surface 79d, the first rotational driving D1a is executed first, and then the contact portion 76b stops on the first inclined surface 79d without coming into contact with the second inclined surface 79e.

In the above description, the controller 90 reduces the output torque Tm of the motor 20 each time the first rotational driving D1a and the second rotational driving D2a are executed, but is not limited thereto. The controller 90 may reduce the output torque Tm of the motor 20 each time the first rotational driving D1a and the second rotational driving D2a are executed once. That is, after executing the first rotational driving D1a and the second rotational driving D2a with the same output torque Tm, the controller 90 may reduce the output torque Tm and execute the next first rotational driving D1a and second rotational driving D2a.

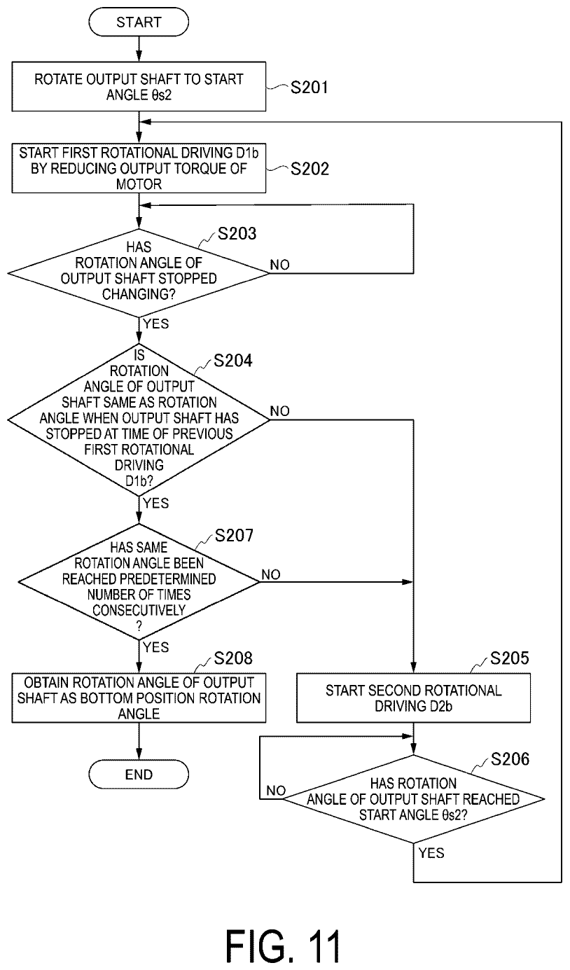

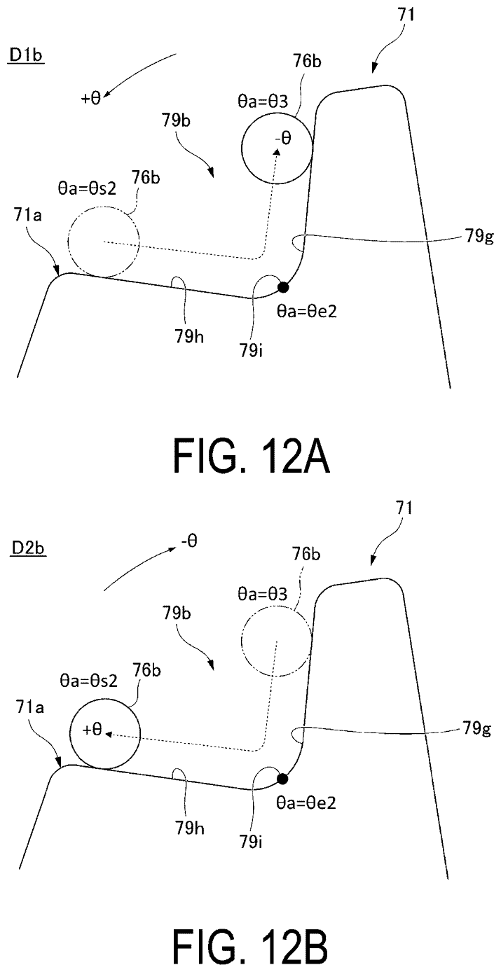

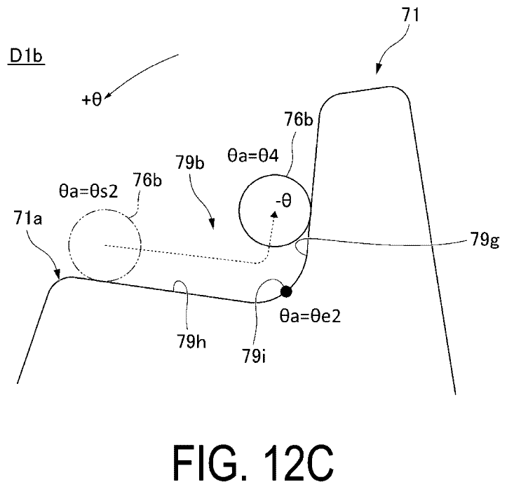

FIG. 11 is a flowchart illustrating an example of obtaining control for the valley portion 79b. As illustrated in FIG. 11, in the obtaining control for the valley portion 79b, the controller 90 rotates the output shaft 46 to the start angle θs2 (step S201). The start angle θs2 is the rotation angle θa at which the contact position P corresponds to the valley portion 79b, and is stored in the controller 90 in advance. The start angle θs2 is a predetermined angle at which the contact position P corresponds to the second inclined surface 79h. The start angle θs2 is an angle at which the contact position P is on the second inclined surface 79h even when the contact position P is shifted due to tolerances. In FIG. 12A, the contact portion 76b when the rotation angle θa of the output shaft 46 reaches the start angle θs2 is indicated by a two dot chain line.

As illustrated in FIG. 11, after rotating the output shaft 46 to the start angle θs2, the controller 90 starts the first rotational driving D1b by reducing the output torque Tm of the motor 20 (step S202). The first rotational driving D1b is a drive for rotating the output shaft 46 to the one side (+θ side) in the circumferential direction around the central axis J1. The output torque Tm of the motor 20 in the first rotational driving D1b is smaller than the output torque Tm at which the contact portion 76b can climb over the first inclined surface 79g. The other features of the first rotational driving D1b are the same as the other features of the first rotational driving D1a in the obtaining control for the valley portion 79a.

As illustrated in FIG. 12A, when the first rotational driving D1b is executed and the output shaft 46 is rotated to the one side (+θ side) in the circumferential direction, the contact portion 76b moves to the other side (−θ side) in the circumferential direction relative to the detent plate 71. When the first rotational driving D1b is executed, the contact portion 76b in contact with the second inclined surface 79h moves down the second inclined surface 79h, passes through the bottom portion 79i, and then moves up the first inclined surface 79g. Here, as described above, the output torque Tm of the motor 20 in the first rotational driving D1b is smaller than the output torque Tm at which the contact portion 76b can climb over the first inclined surface 79g. Therefore, when the first rotational driving D1b is executed, after the contact portion 76b starts to climb up the first inclined surface 79g, there is a timing at which the contact portion 76b cannot climb up the first inclined surface 79g and the output shaft 46 stops rotating.

As illustrated in FIG. 11, after starting the first rotational driving D1b, the controller 90 determines whether the rotation angle θa of the output shaft 46 has stopped changing (step S203), similarly to the above-described step S103. When the controller 90 determines that the rotation angle θa of the output shaft 46 is changing in step S203 (step S203: NO), the controller 90 continues the first rotational driving D1b. When the controller 90 determines that the rotation angle θa of the output shaft 46 does not change in step S203 (step S203: YES), the controller 90 determines whether the rotation angle θa of the stopped output shaft 46 is the same as the rotation angle θa when the output shaft 46 has stopped in the previous first rotational driving D1b (step S204).

In the controller 90 in step S204, the case where the rotation angle θa of the stopped output shaft 46 is the same as the rotation angle θa when the output shaft 46 has stopped in the previous first rotational driving D1b includes a case where the rotation angle θa of the stopped output shaft 46 is exactly the same as the rotation angle θa when the output shaft 46 has stopped in the previous first rotational driving D1b, and a case where the rotation angle θa of the stopped output shaft 46 is substantially the same as the rotation angle θa when the output shaft 46 has stopped in the previous first rotational driving D1b. The case where the rotation angle θa of the stopped output shaft 46 is substantially the same as the rotation angle θa when the output shaft 46 has stopped at the time of the previous first rotational driving D1b includes, for example, a case where even if the rotation angles θa are different from each other, the difference between the rotation angles θa is small enough to fall within the range of tolerances such as variations in the detection value of the rotation sensor 95, and the rotation angles θa can be regarded as substantially the same. The controller 90 stores a second predetermined value determined based on the maximum value of the difference between the rotation angles θa when the rotation angles θa can be regarded as substantially the same. The second predetermined value is equal to or greater than the maximum value of the difference between the rotation angles θa when the rotation angles θa can be regarded as substantially the same. The second predetermined value may be the same as or different from the first predetermined value described above. In step S204, when the difference between the rotation angle θa of the stopped output shaft 46 and the rotation angle θa when the output shaft 46 has stopped in the previous first rotational driving D1b is equal to or less than the second predetermined value, the controller 90 determines that the rotation angle θa of the stopped output shaft 46 is the same as the rotation angle θa when the output shaft 46 has stopped in the previous first rotational driving D1b (step S204: YES). In step S204, when the difference between the rotation angle θa of the stopped output shaft 46 and the rotation angle θa when the output shaft 46 has stopped in the previous first rotational driving D1b is larger than the second predetermined value, the controller 90 determines that the rotation angle θa of the stopped output shaft 46 is not the same as the rotation angle θa when the output shaft 46 has stopped in the previous first rotational driving D1b (step S204: NO).

When the first rotational driving D1b is executed for the first time after the obtaining control is started, the previous first rotational driving D1b does not exist. In this case, the controller 90 determines that the rotation angle θa of the output shaft 46 is not the same as the rotation angle θa when the output shaft 46 has stopped at the time of the previous first rotational driving D1b (step S204: NO). When the controller 90 determines that the rotation angle θa of the output shaft 46 stopped in step S204 is not the same as the rotation angle θa when the output shaft 46 has stopped in the previous first rotational driving D1b (step S204: NO), the controller 90 ends the first rotational driving D1b and starts the second rotational driving D2b (step S205). FIG. 12A illustrates a case where the rotation of the output shaft 46 is stopped by the first rotational driving D1b when the rotation angle θa is an angle θ3. The timing of ending the first rotational driving D1b may be a timing after step S203 and before step S204 is executed.

The second rotational driving D2b is a drive for rotating the output shaft 46 to the other side (−θ side) in the circumferential direction around the central axis J1. The second rotational driving D2b is a drive such that the rotation angle θa of the output shaft 46 is returned to the start angle θs2. The output torque Tm of the motor 20 in the second rotational driving D2b is greater than the output torque Tm of the motor 20 in the first rotational driving D1b. The output torque Tm of the motor 20 in the second rotational driving D2b is, for example, the torque Ta described above. As illustrated in FIG. 12B, when the second rotational driving D2b is executed and the output shaft 46 is rotated to the other side (−θ side) in the circumferential direction, the contact portion 76b moves to the one side (+θ side) in the circumferential direction relative to the detent plate 71. When the second rotational driving D2b is executed, the contact portion 76b in contact with the first inclined surface 79g moves down the first inclined surface 79g, passes through the bottom portion 79i, and then moves up the second inclined surface 79h.

As illustrated in FIG. 11, after starting the second rotational driving D2b, the controller 90 determines whether the rotation angle θa of the output shaft 46 has reached the start angle θs2 (step S206). In step S206, the controller 90 determines that the rotation angle θa has reached the start angle θs2 when the rotation angle θa is exactly the same as the start angle θs2 or when the rotation angle θa is substantially the same as the start angle θs2. The case where the rotation angle θa is substantially the same as the start angle θs2 includes a case where the difference between the rotation angle θa and the start angle θs2 is small enough to fall within the range of tolerances of position control in the second rotational driving D2b, variations in the detection value of the rotation sensor 95, or the like, and the rotation angle θa can be substantially regarded as the start angle θs2. The controller 90 stores a third predetermined value determined based on the maximum value of the difference between the rotation angle θa and the start angle θs2 when the rotation angle θa can be substantially regarded as the start angle θs2. The third predetermined value is equal to or greater than the maximum value of the difference between the rotation angle θa and the start angle θs2 when the rotation angle θa can be substantially regarded as the start angle θs2. The third predetermined value may be the same as or different from the first predetermined value and the second predetermined value described above. In step S206, in a case where the difference between the rotation angle θa and the start angle θs2 is equal to or less than the third predetermined value, the controller 90 determines that the rotation angle θa reaches the start angle θs2 (step S206: YES). In step S206, in a case where the difference between the rotation angle θa and the start angle θs2 is larger than the third predetermined value, the controller 90 determines that the rotation angle θa has not reached the start angle θs2 (step S206: NO).

When the controller 90 determines that the rotation angle θa of the output shaft 46 has not reached the start angle θs2 in step S206 (step S206: NO), the controller 90 continues the second rotational driving D2b. When the controller 90 determines that the rotation angle θa of the output shaft 46 has reached the start angle θs2 in step S206 (step S206: YES), the controller 90 executes step S202 again and starts the first rotational driving D1b. That is, the obtaining control includes switching from the second rotational driving D2b to the first rotational driving D1b when it is determined that the rotation angle θa of the output shaft 46 in the second rotational driving D2b reaches the start angle θs2 that is the predetermined angle. When executing the first rotational driving D1b in step S202 again, the controller 90 sets the output torque Tm of the motor 20 to be smaller than the output torque Tm of the motor 20 in the previous first rotational driving D1b. That is, the controller 90 reduces the output torque Tm of the motor 20 in the first rotational driving D1b each time the first rotational driving D1b is performed.

After the first rotational driving D1b is started again, the controller 90 executes steps S203 and S204, and when it is determined in step S204 that the rotation angle θa of the output shaft 46 is not the same as the rotation angle θa when the output shaft 46 has stopped in the previous first rotational driving D1b (step S204: NO), the second rotational driving D2b is started again (step S205). In this manner, in the obtaining control for the valley portion 79b, the first rotational driving D1b and the second rotational driving D2b are alternately repeated. FIG. 12C illustrates a state after the first rotational driving D1b is executed for the second time. FIG. 12C illustrates a case where the rotation of the output shaft 46 is stopped by the first rotational driving D1b when the rotation angle θa is an angle θ4. The angle θ4 is a rotation angle θa at which the contact portion 76b is positioned closer to the bottom portion 79i than the angle θ3. Since the output torque Tm of the motor 20 in the first rotational driving D1b is reduced each time the first rotational driving D1b is executed, the length that the contact portion 76b can climb up the first inclined surface 79g decreases each time the first rotational driving D1b is executed. Therefore, the contact position P of the contact portion 76b at the end of the first rotational driving D1b approaches the bottom portion 79i each time the first rotational driving D1b is executed.

When the controller 90 determines in step S204 that the rotation angle θa of the output shaft 46 is the same as the rotation angle θa when the output shaft 46 has stopped in the previous first rotational driving D1b (step S204: YES), the controller 90 determines whether the rotation angle θa when the output shaft 46 is stopped in the first rotational driving D1b has been the same rotation angle θa continuously for a predetermined number of times (step S207). The predetermined number of times is an integer of 2 or more. The predetermined number of times is, for example, three. When the controller 90 determines in step S207 that the rotation angle θa when the output shaft 46 is stopped in the first rotational driving D1b has not been the same rotation angle θa continuously for the predetermined number of times (step S207: NO), the controller 90 starts the second rotational driving D2b again (step S205). When the controller 90 determines in step S207 that the rotation angle θa when the output shaft 46 is stopped in the first rotational driving D1b has been the same rotation angle θa continuously for a predetermined number of times (step S207: YES), the controller 90 obtains the rotation angle θa as the bottom position rotation angle θe2 of the valley portion 79b (step S208). That is, the obtaining control includes obtaining the rotation angle θa of the output shaft 46 as the bottom position rotation angle θe2 in a case where the rotation angle θa of the output shaft 46 when it is determined that the rotation angle θa of the output shaft 46 is stopped changing in the first rotational driving D1b is the same twice or more in succession. In the obtaining control in step S208, the rotation angle θa after the power supply to the motor 20 is stopped is obtained to be the bottom position rotation angle θe2. Thus, the obtaining control for the valley portion 79b is completed.

According to the present example embodiment, the obtaining control for the valley portion 79b includes, from a state where the rotation angle θa of the output shaft 46 is the start angle θs2 at which the contact position P becomes the valley portion 79b, alternately repeating the first rotational driving D1b for rotating the output shaft 46 to the one side in the circumferential direction around the central axis J1 and the second rotational driving D2b for rotating the output shaft to the other side in the circumferential direction around the central axis J1, setting the output torque Tm of the motor 20 in the first rotational driving D1b to be smaller than the output torque Tm at which the contact portion 76b can climb over the first inclined surface 79g, switching from the first rotational driving D1b to the second rotational driving D2b when it is determined that the output shaft 46 has stopped in the first rotational driving D1b, and reducing the output torque Tm of the motor 20 in the first rotational driving D1b each time the first rotational driving D1b is performed. Therefore, the bottom position rotation angle θe2 can be accurately obtained in the same manner as the obtaining control for the valley portion 79a. Therefore, the rotation angle θa of the output shaft 46 can be accurately learned.

Further, according to the present example embodiment, the obtaining control for the valley portion 79b includes obtaining the rotation angle θa of the output shaft 46 as the bottom position rotation angle θe2 in a case where the rotation angle θa of the output shaft 46 when it is determined that the rotation angle θa of the output shaft 46 is stopped changing in the first rotational driving D1b is the same twice or more in succession. In the obtaining control for the valley portion 79b, since the output torque Tm of the motor 20 is reduced each time the first rotational driving D1b is performed, the rotation angle θa at which the output shaft 46 stops rotating in the first rotational driving D1b approaches the bottom position rotation angle θe2 each time the first rotational driving D1b is performed. Therefore, when the first rotational driving D1b is repeated with the second rotational driving D2b interposed therebetween, the contact position P of the contact portion 76b approaches the bottom portion 79i when the rotation of the output shaft 46 is stopped in the first rotational driving D1b, and the contact position P is finally at the bottom portion 79i. When the contact position P corresponds to the bottom portion 79i, even if the first rotational driving D1b is executed by reducing the output torque Tm thereafter, the rotation angle θa at which the output shaft 46 stops rotating becomes the same. Therefore, it can be determined that the rotation angle θa of the output shaft 46 is the bottom position rotation angle θe2 at which the contact portion 76b contacts the bottom portion 79i, if the rotation angle θa at which the output shaft 46 stops has been the same twice or more when the first rotational driving D1b is executed. Therefore, in the above-described step S207, the bottom position rotation angle θe2 can be accurately obtained by obtaining the rotation angle θa as the bottom position rotation angle θe2 when it is determined that the rotation angle θa at which the output shaft 46 is stopped in the first rotational driving D1b has been the same rotation angle θa continuously for a predetermined number of times that is two or more. Therefore, the rotation angle θa of the output shaft 46 can be accurately learned. Further, by setting the predetermined number of times to three or more, even if an erroneous determination is made at step S204, it is possible to prevent an erroneous rotation angle θa from being obtained to be the bottom position rotation angle θe2.

Note that the predetermined number of times may be two. In this case, the controller 90 may omit step S207, and may execute step S208 when it is determined in step S204 that the rotation angle θa of the output shaft 46 is the same as the rotation angle θa at the time of stopping in the previous first rotational driving D1b.

Further, according to the present example embodiment, the obtaining control for the valley portion 79b includes switching from the second rotational driving D2b to the first rotational driving D1b when it is determined that the rotation angle θa of the output shaft 46 in the second rotational driving D2b reaches the predetermined angle at which the contact position P corresponds to the second inclined surface 79h, that is, the start angle θs2. Therefore, in the obtaining control for the valley portion 79b, it is not necessary to adjust the output torque Tm of the motor 20 in the second rotational driving D2b, and the second rotational driving D2b is simply a drive for setting the rotation angle θa to a predetermined angle, that is, the start angle θs2. Therefore, it is possible to prevent the contact position P from deviating from the valley portion 79b when the second rotational driving D2b is executed, and it is possible to easily execute the second rotational driving D2b. In the above description, the predetermined angle, which is the target value of the rotation angle θa in the second rotational driving D2b, is the start angle θs2, but is not limited thereto. The predetermined angle is not particularly limited as long as the contact position P corresponds to the second inclined surface 79h, and may be an angle other than the start angle θs2.

Further, according to the present example embodiment, the electric actuator 10 includes a function of maintaining the rotation angle θa of the output shaft 46 when electric power is not supplied to the motor 20. When viewed in the axial direction of the central axis J1, the absolute inclination angle of the first inclined surface 79g with respect to the circumferential direction around the central axis J1 is larger than the absolute inclination angle of the second inclined surface 79h with respect to the circumferential direction around the central axis J1. In the related art, for the valley portion 79b including the first inclined surface 79g and the second inclined surface 79h, it is conceivable to obtain the bottom position rotation angle θe2 by abutting learning control in which the contact portion 76b is abutted against the first inclined surface 79g having a large inclination angle with respect to the circumferential direction. However, in a case where the electric actuator 10 includes a self-holding function for holding the rotation angle θa of the output shaft 46, if the contact portion 76b climbs the first inclined surface 79g when the contact portion 76b abuts against the first inclined surface 79g, the position of the contact portion 76b stops changing even if the contact portion 76b receives a force from the plate spring member 76 after the power supply to the motor 20 is stopped. Therefore, when the electric actuator 10 includes the self-holding function, there is a problem that the bottom position rotation angle θe2 cannot be accurately obtained in the known abutting learning control. On the other hand, according to the present example embodiment, the bottom position rotation angle θe2 of the valley portion 79b can be accurately obtained by executing the obtaining control for the valley portion 79b described above.

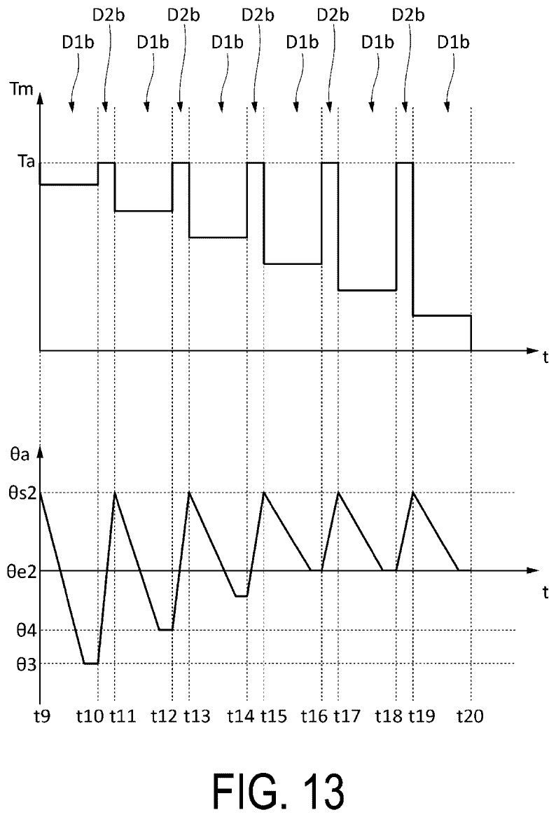

FIG. 13 is a diagram illustrating an example of a change in the output torque Tm of the motor 20 and a change in the rotation angle θa of the output shaft 46 in the obtaining control for the valley portion 79b. In the upper graph of FIG. 13, the vertical axis represents the output torque Tm, and the horizontal axis represents the time t. In the lower graph of FIG. 13, the vertical axis represents the rotation angle θa of the output shaft 46, and the horizontal axis represents the time t. In FIG. 13, the rotation angle θa at the time t9 is the start angle θs2. The first rotational driving D1b is executed from the time t9 to the time t10, from the time t11 to the time t12, from the time t13 to the time t14, from the time t15 to the time t16, from the time t17 to the time t18, and from the time t19 to the time t20. The second rotational driving D2b is executed from the time t10 to the time t11, from the time t12 to the time t13, from the time t14 to the time t15, from the time t16 to the time t17, and from the time t18 to the time t19.

As illustrated in the lower graph of FIG. 13, in the obtaining control for the valley portion 79b, the rotation angle θa approaches the bottom position rotation angle θe2 in the valley portion 79b each time the first rotational driving D1b is executed. As illustrated in the upper graph of FIG. 13, the output torque Tm in the first rotational driving D1b is reduced each time the first rotational driving D1b is performed. In the example of FIG. 13, the output torque Tm in the second rotational driving D2b is the torque Ta at any second rotational driving D2b. In the example of FIG. 13, the rotation angle θa reaches the bottom position rotation angle θe2 by the first rotational driving D1b executed from the time t15 to the time t16. In the example of FIG. 13, when the rotation angle θa has been the same three consecutive times from the time t15 to the time t16, from the time t17 to the time t18, and from the time t19 to the time t20, the controller 90 obtains the rotation angle θa as the bottom position rotation angle θe2.

The obtaining control for the valley portion 79c is the same as the obtaining control for the valley portion 79a or the obtaining control for the valley portion 79b. Here, the valley portion 79c is different from the valley portion 79a and is not the valley portion 79 provided between the valley portions 79. Therefore, in the related art, it is conceivable to set the size of the first inclined surface 79j in the radial direction to a height that the contact portion 76b cannot climb over, and obtain the bottom position rotation angle by the abutting learning control. However, there is a case where the size of the first inclined surface 79j in the radial direction cannot be sufficiently increased due to the arrangement of other devices. In this case, the known abutting learning control cannot be adopted as in the case of the valley portion 79a. Even if the first inclined surface 79j is formed to have a size that enables the abutting learning control, the bottom position rotation angle may not be accurately obtained due to the self-holding function of the electric actuator 10, as in the case of the above-described valley portion 79b. On the other hand, the controller 90 can obtain the bottom position rotation angle in the valley portion 79c by executing the obtaining control for the valley portion 79a or the obtaining control for the valley portion 79b described above for the valley portion 79c. In the obtaining control for the valley portion 79c, the +θ side is the other side in the circumferential direction, and the −θ side is the one side in the circumferential direction.

The obtaining control for the valley portion 79a described above can also be applied to the valley portion 79b. The obtaining control for the valley portion 79b described above can also be applied to the valley portion 79a.

The controller 90 is a computer that executes a learning method including the obtaining control according to the present example embodiment described above. A program for causing the controller 90, which is a computer, to execute a learning method including the above-described obtaining control is installed in the controller 90. At least some of the functions of the constituent elements of the controller 90 are implemented, for example, by executing a program stored in a storage unit (not illustrated), that is, software.

At least a portion of the function of each component of the controller 90 may be implemented by hardware including a circuit unit such as a large scale integration (LSI), an application specific integrated circuit (ASIC), a field-programmable gate array (FPGA), and a graphics processing unit (GPU), or may be implemented by software and hardware in cooperation. A storage unit (not illustrated) in which a program for causing the controller 90, which is a computer, to execute the learning method including the obtaining control of the present example embodiment described above is stored is implemented by a storage medium such as a random access memory (RAM), a read only memory (ROM), a hard disk drive (HDD), and a flash memory. The storage unit is not particularly limited as long as it can store a program that causes a computer to execute the learning method including the obtaining control of the present example embodiment described above, and may be a microcomputer or a disk medium such as a CD-ROM. The storage unit may be provided separately from the controller 90. In this case, the controller 90 may communicate with the storage unit through wired communication or wireless communication and execute a program stored in the storage unit.

The present disclosure is not limited to the above-described example embodiments, and other configurations and methods can be adopted within the scope of the technical idea of the present disclosure. The number of valley portions provided on the outer peripheral edge of the first portion (detent plate) is not particularly limited as long as it is one or more. The number of valley portions may be two or may be four or more. The first rotational driving and the second rotational driving that are alternately repeated may be started from either rotational driving.

In the above-described example embodiment, the rotor in the motor of the electric actuator is configured to rotate around the central axis J1 of the output shaft, but is not limited thereto. The rotor may be rotatable about an axis different from the central axis J1 of the output shaft. The axis different from the central axis J1 may be an axis parallel to the central axis J1 and located at a different position in the radial direction, or may be an axis extending in a direction intersecting the axial direction of the central axis J1. The use of the electric actuator to which the present disclosure is applied is not particularly limited. The electric actuator may be mounted on any device.

Note that example embodiments of the present disclosure can have configurations such as the following.
(1) An electric actuator configured to rotationally drive a first portion having a plate shape, the plate shape including a plate surface and an outer peripheral edge, around a central axis orthogonal or substantially orthogonal to the plate surface to change a contact position of a second portion including a contact portion, the contact portion being in contact with the outer peripheral edge, the electric actuator including an output shaft coupled to the first portion, a motor to rotate the output shaft around the central axis, a rotation sensor to detect a rotation angle of the output shaft, and a controller configured or programmed to control the motor, in which the outer peripheral edge includes a valley portion, the valley portion includes a first inclined surface, a second inclined surface located on one side of the first inclined surface in a circumferential direction around the central axis, and a bottom portion to connect the first inclined surface and the second inclined surface, the controller is configured or programmed to execute obtaining control to obtain, as a bottom position rotation angle, a rotation angle of the output shaft at a time when the contact position corresponds to the bottom portion, and the obtaining control includes from a state where a rotation angle of the output shaft is a start angle at which the contact position corresponds to the valley portion, alternately repeating first rotational driving to rotate the output shaft to one side in the circumferential direction around the central axis and second rotational driving to rotate the output shaft to another side in the circumferential direction around the central axis, setting an output torque of the motor in the first rotational driving to be smaller than an output torque that allows the contact portion to climb over the first inclined surface, switching from the first rotational driving to the second rotational driving when the output shaft is determined to be stopped in the first rotational driving, and reducing the output torque of the motor in the first rotational driving each time the first rotational driving is performed.
(2) The electric actuator according to (1), in which the obtaining control includes setting an output torque of the motor in the second rotational driving to be smaller than an output torque that allows the contact portion to climb over the second inclined surface, switching from the second rotational driving to the first rotational driving when a rotation angle of the output shaft is determined to remain unchanged in the second rotational driving, reducing the output torque of the motor in the second rotational driving each time the second rotational driving is performed, and obtaining a rotation angle of the output shaft as the bottom position rotation angle when rotational driving is switched from one of the first rotational driving and the second rotational driving to another of the first rotational driving and the second rotational driving and when a rotation angle of the output shaft remains unchanged even if the other of the first rotational driving and the second rotational driving is executed.
(3) The electric actuator according to (2), in which the obtaining control includes setting the output torque of the motor in the second rotational driving to be smaller than the output torque of the motor in the first rotational driving performed immediately before the second rotational driving.
(4) The electric actuator according to (1), in which the obtaining control includes obtaining, when a rotation angle of the output shaft is determined to remain unchanged in the first rotational driving and when the rotation angle of the output shaft has been the same for two or more consecutive times, the rotation angle of the output shaft as the bottom position rotation angle.
(5) The electric actuator according to (4), in which the obtaining control includes switching from the second rotational driving to the first rotational driving when a rotation angle of the output shaft is determined to have reached a predetermined angle at which the contact position corresponds to the second inclined surface in the second rotational driving.
(6) The electric actuator according to any one of (1) to (5), in which the outer peripheral edge includes three or more of the valley portions provided side by side in the circumferential direction around the central axis, and the controller is configured or programmed to execute the obtaining control in the valley portion located between the valley portion located closest to the one side in the circumferential direction around the central axis and the valley portion located closest to the other side in the circumferential direction around the central axis, among the three or more valley portions.
(7) The electric actuator according to any one of (1) to (6), including a function of holding a rotation angle of the output shaft when power is not supplied to the motor, in which an absolute value of an inclination angle of the first inclined surface with respect to the circumferential direction around the central axis is larger than an absolute value of an inclination angle of the second inclined surface with respect to the circumferential direction around the central axis as viewed in the axial direction of the central axis.

The configurations and methods of example embodiments described above in the present specification can be combined as appropriate within a range in which they do not contradict each other.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric actuator configured to rotationally drive a first portion having a plate shape, the plate shape including a plate surface and an outer peripheral edge, around a central axis orthogonal or substantially orthogonal to the plate surface to change a contact position of a second portion including a contact portion, the contact portion being in contact with the outer peripheral edge, the electric actuator comprising:
an output shaft coupled to the first portion;
a motor to rotate the output shaft around the central axis;
a rotation sensor to detect a rotation angle of the output shaft; and
a controller configured or programmed to control the motor;
wherein
the outer peripheral edge includes a valley portion;
the valley portion includes:
a first inclined surface;
a second inclined surface located on one side of the first inclined surface in a circumferential direction around the central axis; and
a bottom portion to connect the first inclined surface and the second inclined surface;
the controller is configured or programmed to execute obtaining control to obtain, as a bottom position rotation angle, a rotation angle of the output shaft at a time when the contact position corresponds to the bottom portion; and
the obtaining control includes:
from a state where a rotation angle of the output shaft is a start angle at which the contact position corresponds to the valley portion, alternately repeating first rotational driving to rotate the output shaft to one side in the circumferential direction around the central axis and second rotational driving to rotate the output shaft to another side in the circumferential direction around the central axis;
setting an output torque of the motor in the first rotational driving to be smaller than an output torque that allows the contact portion to climb over the first inclined surface;
switching from the first rotational driving to the second rotational driving when the output shaft is determined to be stopped in the first rotational driving; and
reducing the output torque of the motor in the first rotational driving each time the first rotational driving is performed.

2. The electric actuator according to claim 1, wherein
the obtaining control includes:
setting an output torque of the motor in the second rotational driving to be smaller than an output torque that allows the contact portion to climb over the second inclined surface;
switching from the second rotational driving to the first rotational driving when a rotation angle of the output shaft is determined to remain unchanged in the second rotational driving;
reducing the output torque of the motor in the second rotational driving each time the second rotational driving is performed; and
obtaining a rotation angle of the output shaft as the bottom position rotation angle when rotational driving is switched from one of the first rotational driving and the second rotational driving to the other of the first rotational driving and the second rotational driving and when a rotation angle of the output shaft remains unchanged even if the other of the first rotational driving and the second rotational driving is executed.

3. The electric actuator according to claim 2, wherein the obtaining control includes setting the output torque of the motor in the second rotational driving to be smaller than the output torque of the motor in the first rotational driving performed immediately before the second rotational driving.

4. The electric actuator according to claim 1, wherein the obtaining control includes obtaining, when a rotation angle of the output shaft is determined to remain unchanged in the first rotational driving and when the rotation angle of the output shaft has been the same for two or more consecutive times, the rotation angle of the output shaft as the bottom position rotation angle.

5. The electric actuator according to claim 4, wherein the obtaining control includes switching from the second rotational driving to the first rotational driving when a rotation angle of the output shaft is determined to have reached a predetermined angle at which the contact position corresponds to the second inclined surface in the second rotational driving.

6. The electric actuator according to claim 1, wherein
the outer peripheral edge includes three or more of the valley portions provided side by side in the circumferential direction around the central axis; and
the controller is configured or programmed to execute the obtaining control in the valley portion located between the valley portion located closest to the one side in the circumferential direction around the central axis and the valley portion located closest to the other side in the circumferential direction around the central axis, among the three or more valley portions.

7. The electric actuator according to claim 1, wherein
the electric actuator is configured to hold a rotation angle of the output shaft when power is not supplied to the motor;
an absolute value of an inclination angle of the first inclined surface with respect to the circumferential direction around the central axis is larger than an absolute value of an inclination angle of the second inclined surface with respect to the circumferential direction around the central axis as viewed in the axial direction of the central axis.
